(19) United States
(12) Patent Application Publication
(10) Pub. No.: US 2025/0176545 A1
(43) Pub. Date: Jun. 5, 2025

(54) LIQUID PESTICIDAL COMPOSITION

(71) Applicant: SUMITOMO CHEMICAL COMPANY, LIMITED, Tokyo (JP)

(72) Inventor: Atsushi OKA, Takarazuka-shi (JP)

(73) Assignee: SUMITOMO CHEMICAL COMPANY, LIMITED, Tokyo (JP)

(21) Appl. No.: 18/726,440

(22) PCT Filed: May 23, 2023
(86) PCT No.: PCT/JP2023/019091

§ 371 Date: Jul. 3, 2024

(30) Foreign Application Priority Data
May 25, 2022 (JP) 2022-085180

(51) Int. Cl. A01N 37/40; A01N 25/02; A01P 13/00

(52) U.S. Cl. CPC A01N 37/40; A01N 25/02; A01P 13/00

(57) ABSTRACT

To provide a pesticidal composition comprising an auxin herbicide, particularly a dicamba amine salt, and another specific pesticidal active compound, which is capable of inhibiting volatilization of the auxin herbicide and inhibiting decomposition of the specific pesticidal active compound.

Provided is a liquid pesticidal composition comprising: at least one herbicide selected from the group consisting of an auxin herbicide and an agriculturally acceptable salt or ester thereof; a pesticidal active compound having a partial structure represented by formula (I): —C(═O)—X—, wherein X represents at least one selected from the group consisting of an oxygen atom and NR¹, and R¹ represents a monovalent group; and at least one selected from the group consisting of a polycarboxylic acid and a salt thereof.

### TECHNICAL FIELD

The present invention relates to a liquid pesticidal composition.

### BACKGROUND ART

U.S. Pat. No. 9,743,664 (Patent Document 1) mentions that volatilization of an auxin herbicide can be inhibited by adding a monocarboxylic acid or a salt thereof and a base such as potassium hydroxide to a pesticidal composition comprising an auxin herbicide or a salt thereof.

### PRIOR ART DOCUMENT

### Patent Document

[Patent Document 1]U.S. Pat. No. 9,743,664

### DISCLOSURE OF THE INVENTION

### Problems to be Solved by the Invention

When the above prior art is applied to a pesticidal composition comprising, in addition to an auxin herbicide, another specific pesticidal active compound, volatilization of the auxin herbicide can be inhibited, but there is a problem that the specific pesticidal active compound is decomposed.

An object of the present invention is to provide a pesticidal composition comprising an auxin herbicide, particularly a dicamba amine salt, and another specific pesticidal active compound, which is capable of inhibiting volatilization of the auxin herbicide and inhibiting decomposition of the specific pesticidal active compound.

### Means for Solving the Problems

The present invention provides the following liquid pesticidal compositions.
[1]A liquid pesticidal composition comprising:
   at least one herbicide selected from the group consisting of an auxin herbicide and an agriculturally acceptable salt or ester thereof;
   a pesticidal active compound having a partial structure represented by the following formula (I):

—C(═O)—X— (I)
wherein X represents at least one selected from the group consisting of an oxygen atom and NR¹, and R¹ represents a monovalent group; and
   at least one selected from the group consisting of a polycarboxylic acid and a salt thereof.
[2] The liquid pesticidal composition according to [1], wherein at least one herbicide comprises a dicamba amine salt.
[3] The liquid pesticidal composition according to [2], wherein the pesticidal active compound is a compound represented by the following formula (I-1):

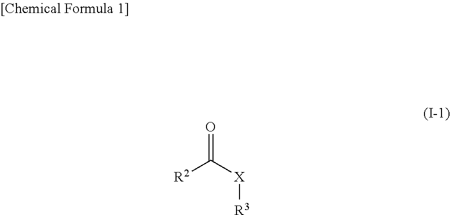

wherein X is as defined above,
   R² represents a monovalent group,
   R³ represents a monovalent group when X is an oxygen atom, or C(═O)—R⁴ when X is NR¹, and
   R⁴ represents a monovalent group, and R² and R⁴ may form a ring together with the carbon atom to which R² is bonded, X and the carbon atom to which R⁴ is bonded.
[4] The liquid pesticidal composition according to [2] or [3], wherein the polycarboxylic acid comprises at least one polycarboxylic acid selected from the group consisting of a copolymer of acrylic acid and maleic acid, and polyacrylic acid.
[5] The liquid pesticidal composition according to any one of [2] to [4], wherein the dicamba amine salt comprises at least one dicamba amine salt selected from the group consisting of a dicamba diglycolamine salt and a dicamba monoethanolamine salt.
[6] The liquid pesticidal composition according to any one of [2] to [5], further comprising a basic component.
[7] The liquid pesticidal composition according to any one of [2] to [5], further comprising an alkali metal hydroxide.
[8] The liquid pesticidal composition according to any one of [2] to [5], further comprising at least one alkali metal hydroxide selected from the group consisting of a potassium hydroxide and a sodium hydroxide.
[9] The liquid pesticidal composition according to [6], wherein the concentration of the basic component is 0.0001 mol/L or more and 0.050 mol/L or less.
[10] The liquid pesticidal composition according to any one of [2] to [9], wherein the pesticidal active compound comprises a PPO inhibitor.
[11] The liquid pesticidal composition according to any one of [2] to [10], wherein the pesticidal active compound is a compound represented by the following formula (I-1a):

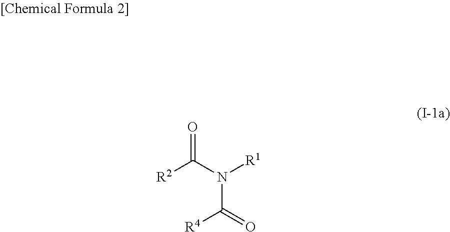

wherein R¹ represents a monovalent group,
   R² represents a monovalent group, and
   R⁴ represents a monovalent group, and R² and R⁴ may form a ring together with the carbon atom to which R² is bonded, an N atom and the carbon atom to which R⁴ is bonded.
[12] The liquid pesticidal composition according to [11], wherein the compound represented by the above formula (I-1a) is a compound represented by the following formula (I-1aa):

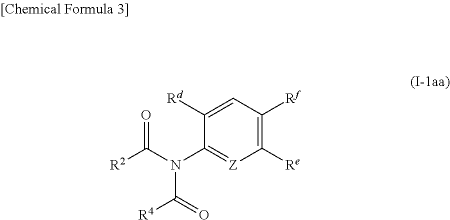

wherein R² represents a monovalent group,
   R⁴ represents a monovalent group, and R² and R⁴ may form a ring together with the carbon atom to which R² is bonded, an N atom and the carbon atom to which R⁴ is bonded,
   R^{d} represents a fluorine atom or a hydrogen atom,
   R^{e} represents a monovalent group which may have one or more heteroatoms,
   R^{f} represents a monovalent group which may have one or more heteroatoms, or a halogen atom, and R^{f} and R^{e} may be taken together to form a ring, and
   Z represents C—H or an N atom.
[13] The liquid pesticidal composition according to any one of [2] to [10], wherein the pesticidal active compound is a compound represented by the following formula (I-1ba):

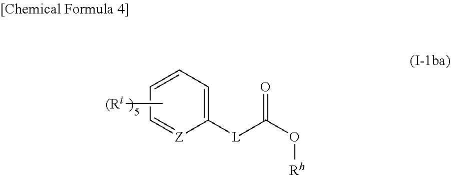

wherein R^{h} represents an alkyl group,
   a plurality of Rⁱ(s) may be the same or different and each independently represent a hydrogen atom, a halogen atom, or a monovalent group which may have one or more heteroatoms,
   L represents an alkylene group which may have a substituent, and one or more —CH₂-(s) included in the alkylene group may be substituted with —O—, —S—, —C(═O)—, —C(═S)—, or —N(R)— [R represents a hydrogen atom or a monovalent group], and
   Z represents C—H or an N atom.
[14] The liquid pesticidal composition according to [13], wherein the compound represented by the above formula (I-1ba) is a compound represented by the following formula (I-1ba′):

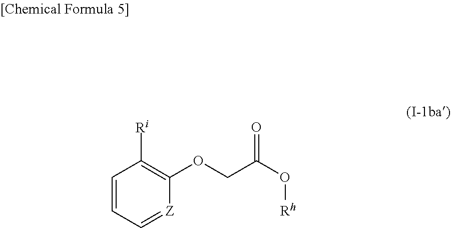

wherein R^{h} represents an alkyl group,
   R^{j} represents a monovalent group which may have one or more heteroatoms, and
   Z represents C—H or an N atom.

### Effects of the Invention

It is possible to provide a pesticidal composition comprising an auxin herbicide, particularly a dicamba amine salt, and another specific pesticidal active compound, which is capable of inhibiting volatilization of the auxin herbicide and inhibiting decomposition of the specific pesticidal active compound.

### BRIEF DESCRIPTION OF THE DRAWINGS

FIG. 1 is a schematic cross-sectional view showing an evaluation device used in Test Example 3.

### MODE FOR CARRYING OUT THE INVENTION

### <Liquid Pesticidal Composition>

The liquid pesticidal composition according to the present invention (hereinafter also simply referred to as “pesticidal composition”) comprises an auxin herbicide, a pesticidal active compound having a partial structure represented by formula (I) (hereinafter also referred to as “compound (I)”), and at least one selected from the group consisting of a polycarboxylic acid and a salt thereof. The pesticidal composition is usually a pesticidal formulation, and its form is not particularly limited as long as it is in a liquid. “Liquid” means that it exhibits fluidity at 25° C. The pesticidal composition may contain an aqueous phase, and preferably contains an aqueous phase and an oil phase.

A detailed description of ingredients that the pesticidal composition comprises or may comprise will now be given.

### [1] Auxin Herbicide and Agriculturally Acceptable Salt or Ester Thereof

Examples of the auxin herbicides include benzoic acid herbicides and phenoxy herbicides.

Examples of the benzoic acid herbicides include dicamba and an agriculturally acceptable salt or ester thereof. In a preferred embodiment, the pesticidal composition comprises a dicamba amine salt. Examples of the dicamba amine salt include a dicamba diglycolamine salt, a dicamba monoethanolamine salt, a dicamba tetrabutylamine salt, a dicamba tetrabutylphosphonium salt, a dicamba N,N-bis(3-aminopropyl)methylamine (BAPMA) salt and a dicamba choline salt. The dicamba amine salt preferably includes at least one dicamba amine salt selected from a dicamba diglycolamine salt and a dicamba monoethanolamine salt, and more preferably includes a dicamba diglycolamine salt. In one embodiment, the pesticidal composition comprises a dicamba amine salt alone or two or more thereof. Some dicamba amine salts can exist in a neutral state in the pesticidal composition. That is, a carboxylate group (—COO⁻ group) possessed by the dicamba amine salt may exist in equilibrium with a carboxy group (—COOH group). In the pesticidal composition, the dicamba amine salt is usually dissolved in the above aqueous phase.

When the total amount of the pesticidal composition is 100% by mass, the content of the dicamba amine salt in the pesticidal composition is preferably 0.1% by mass or more and 80% by mass or less, more preferably 0.5% by mass or more and 70% by mass or less, still more preferably 1% by mass or more and 60% by mass or less, yet more preferably 2% by mass or more and 50% by mass or less, and particularly preferably 5% by mass or more and 30% by mass or less. The content of the dicamba amine salt as used herein is the content of dicamba acid.

When the pesticidal composition comprises two or more dicamba amine salts, the content of the above-mentioned dicamba amine salt is the total content of two or more dicamba amine salts. The same applies to other ingredients that the pesticidal composition comprises or may comprise, and when comprising two or more ingredients, the content and concentration of the ingredients are the total content and total concentration thereof, unless otherwise specified.

The concentration of the dicamba amine salt in the pesticidal composition is usually 0.1 mol/L or more and 5 mol/L or less, preferably 0.2 mol/L or more and 4.5 mol/L or less, more preferably 0.3 mol/L or more and 4 mol/L or less, still more preferably 0.4 mol/L or more and 3.5 mol/L or less, and yet more preferably 0.5 mol/L or more and 3 mol/L or less. The concentration of the dicamba amine salt in the pesticidal composition is the value obtained by dividing the number of mols (mol), which is obtained by dividing the weight of the dicamba amine salt included in the pesticidal composition by the molecular weight, by the volume (L) of the pesticidal composition (mol/L).

Examples of the phenoxy herbicides include 2,4-D and an agriculturally acceptable salt or ester thereof. In a preferred embodiment, the pesticidal composition comprises a 2,4-D amine salt. Examples of the 2,4-D amine salt include a 2,4-D ammonium salt, a 2,4-D diethylammonium salt, a 2,4-D dimethylammonium salt, a 2,4-D diolamine salt, a 2,4-D dodecylammonium salt, a 2,4-D heptylammonium salt, a 2,4-D isopropylammonium salt, a 2,4-D tetradecylammonium salt, a 2,4-D triethylammonium salt, a 2,4-D tris(2-hydroxypropyl)ammonium salt, a 2,4-D trolamine salt and a 2,4-D choline salt. In one embodiment, the pesticidal composition comprises a 2,4-D amine salt alone, or two or more thereof. Some 2,4-D amine salts can exist in a neutral state in the pesticidal composition. That is, a carboxylate group (—COO⁻ group) of the 2,4-D amine salt may exist in equilibrium with a carboxy group (—COOH group). In the pesticidal composition, the 2,4-D amine salt is usually dissolved in the above aqueous phase. The content of the 2,4-D amine salt in the pesticidal composition and the concentration of the 2,4-D amine salt in the pesticidal composition are equivalent to the content and concentration of the dicamba amine salt.

### [2] Compound (I)

The compound (I) is a compound having a partial structure represented by formula (I).

—C(═O)—X— (I)

In the pesticidal composition, the compound (I) may be contained in the above aqueous phase, the above oil phase, or both the aqueous and oil phases when the pesticidal composition comprises two or more compounds (I).

In formula (I), X represents at least one selected from the group consisting of an oxygen atom and NR¹, and R¹ represents a monovalent group. That is, the compound (I) is a compound having one or more structures selected from the group consisting of an ester structure and an amide structure. The compound (I) may have two or more ester structures, two or more amide structures, or one or more ester structures and one or more amide structures. The pesticidal composition may also comprise two or more compounds (I).

The monovalent group represented by R¹ is, for example, a hydrogen atom, a monovalent aliphatic group (including an alicyclic group, the same applies hereinafter), a monovalent aromatic group, and a monovalent group comprising a combination of an aliphatic structure and an aromatic structure, more preferably a monovalent aliphatic group, a monovalent aromatic group, and a monovalent group comprising a combination of an aliphatic structure and an aromatic structure, and still more preferably a monovalent aromatic group, and a monovalent group comprising a combination of an aliphatic structure and an aromatic structure. Each of the monovalent aliphatic group, the monovalent aromatic group, and the monovalent group comprising a combination of an aliphatic structure and an aromatic structure may have one or more substituents, and may also contain one or more heteroatoms. For example, one or more —CH₂-(s) included in these monovalent groups may be substituted with —O—, —S—, —C(═O)—, —C(═S)—, or —N(R)— [R represents a hydrogen atom or a monovalent group].

According to the liquid pesticidal compositions of the present invention, when comprising a dicamba amine salt as an auxin herbicide, it is possible to inhibit volatilization of dicamba and to inhibit decomposition of the compound (I).

The decomposition of the compound (I) is typically accompanied by cleavage of a C—X bond in the above formula (I). The decomposition of the compound (I) is usually involved in a dicamba amine salt coexisting in the pesticidal composition. The decomposition of the compound (I) means the cleavage of at least one bond existing in the compound (I), and also includes the addition of other atoms or molecules to the cleaved site.

The compound (I) is preferably a herbicidal active compound. Examples of the herbicidal active compound include protoporphyrinogen oxidase (PPO) inhibitors, acetyl CoA carboxylase (ACCase) inhibitors, acetolactate synthase (ALS) inhibitors, acetohydroxyacid synthase (AHAS) inhibitors, photosystem I inhibitors, photosystem II inhibitors, carotenoid biosynthesis inhibitors, enolpyruvyl shikimate 3-phosphate (EPSP) synthase inhibitors, glutamine synthetase inhibitors, dihydropteroate synthase inhibitors, mitosis inhibitors, nucleic acid inhibitors and the like. Particularly, the compound (I) preferably comprises PPO inhibitors, and more preferably consists of PPO inhibitors.

Examples of the compound (I) include a compound represented by the following formula (I-1):

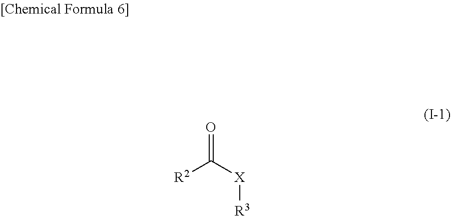

(hereinafter also referred to as “compound (I-1)”).

In formula (I-1), X is as defined above. R² represents a monovalent group. R³ represents a monovalent group when X is an oxygen atom, and C(═O)—R⁴ when X is NR¹. R⁴ represents a monovalent group, and R² and R⁴ may form a ring together with the carbon atom to which R² is bonded, X and the carbon atom to which R⁴ is bonded.

The monovalent group represented by R², R³, and R⁴ each independently include, for example, a monovalent aliphatic group, a monovalent aromatic group, and a monovalent group comprising a combination of an aliphatic structure and an aromatic structure. Each of the monovalent aliphatic group, the monovalent aromatic group, and the monovalent group comprising a combination of an aliphatic structure and an aromatic structure may have one or more substituents, and may also contain one or more heteroatoms. The monovalent group represented by R² is preferably a monovalent group comprising a combination of an aliphatic structure and an aromatic structure. When X is an oxygen atom, the monovalent group represented by R³ is preferably a monovalent aliphatic group, more preferably an alkyl group, still more preferably an alkyl group having 1 to 6 carbon atoms, and yet more preferably an alkyl group having 1 to 4 carbon atoms. The monovalent group represented by R⁴ is preferably a monovalent aliphatic group, or a monovalent group comprising a combination of an aliphatic structure and an aromatic structure.

Each of the monovalent aliphatic group, the monovalent aromatic group, and the monovalent group comprising a combination of an aliphatic structure and an aromatic structure may have one or more substituents, and may also contain one or more heteroatoms. For example, one or more —CH₂-(s) included in these monovalent groups may be substituted with —O—, —S—, —C(═O)—, —C(═S)—, or —N(R)— [R represents a hydrogen atom or a monovalent group].

The compound (I-1) in which X is an oxygen atom and R³ is a monovalent group is a compound having an ester structure. The compound (I-1) in which X is NR¹ and R³ is C(═O)—R⁴ is a compound having an imide structure. The compound having an imide structure may be a compound having a uracil ring structure. The uracil ring structure includes an imide structure. The compound having a uracil ring structure is a compound in which R² and R⁴ may form a ring together with the carbon atom to which R² is bonded, X and the carbon atom to which R⁴ is bonded in formula (I-1), and R² and R⁴ are taken together to form —N(R^{a})—C(R^{b})═C(R^{c})—. R^{a}, R^{b}, and R^{c} are each independently a hydrogen atom or a monovalent group.

### [2-1] Compound Having Imide Structure

Examples of the compound (I-1) having an imide structure include a compound represented by the following formula (I-1a):

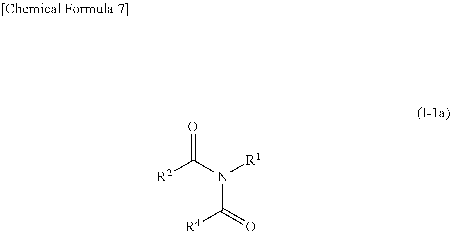

(hereinafter also referred to as “compound (I-1a)”).

In formula (I-1a), R¹, R² and R⁴ are as defined above. R¹ is preferably an aryl group or heteroaryl group which may have one or more substituents, more preferably a phenyl group or pyridyl group which may have one or more substituents, and still more preferably a phenyl group or 2-pyridyl group which may have one or more substituents. Examples of the substituent include a monovalent group which may contain one or more heteroatoms, a halogen atom and the like. The halogen atom is a fluorine atom, a chlorine atom, a bromine atom or an iodine atom, and preferably a fluorine atom or a chlorine atom.

The monovalent group represented by R² and R⁴ each independently include, for example, a monovalent aliphatic group, a monovalent aromatic group, and a monovalent group comprising a combination of an aliphatic structure and an aromatic structure. Each of the monovalent aliphatic group, the monovalent aromatic group, and the monovalent group comprising a combination of an aliphatic structure and an aromatic structure may have one or more substituents, and may also contain one or more heteroatoms. The monovalent group represented by R² is preferably a monovalent group comprising a combination of an aliphatic structure and an aromatic structure. The monovalent group represented by R⁴ is preferably a monovalent aliphatic group, or a monovalent group comprising a combination of an aliphatic structure and an aromatic structure.

R² and R⁴ may form a ring together with the carbon atom to which R² is bonded, an N atom and the carbon atom to which R⁴ is bonded.

Each of the monovalent aliphatic group, the monovalent aromatic group, and the monovalent group comprising a combination of an aliphatic structure and an aromatic structure may have one or more substituents, and may also contain one or more heteroatoms. For example, one or more —CH₂-(s) included in these monovalent groups may be substituted with —O—, —S—, —C(═O)—, —C(═S)—, or —N(R)— [R represents a hydrogen atom or a monovalent group].

In one preferred embodiment, the compound (I-1a) is a compound represented by the following formula (I-1aa):

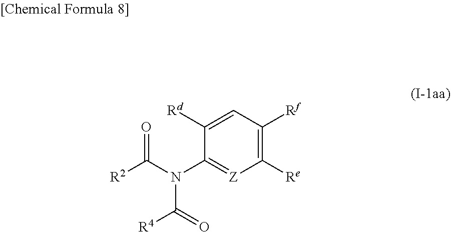

(hereinafter also referred to as “compound (I-1aa)”).

In formula (I-1aa), R² and R⁴ are as defined above. R² and R⁴ may form a ring together with the carbon atom to which R² is bonded, an N atom and the carbon atom to which R⁴ is bonded.

R^{d} represents a fluorine atom or a hydrogen atom. R^{e} represents monovalent group which may contain one or more heteroatoms. R^{f} represents a monovalent group or halogen atom which may contain one or more heteroatoms. R^{f} and R^{P} may be taken together to form a ring. Z represents C—H or N (nitrogen atom). The above halogen atom is a fluorine atom, a chlorine atom, a bromine atom or an iodine atom, and preferably a chlorine atom.

A preferred example of the monovalent group which may contain one or more heteroatoms as for R^{e} is —Y—R^{g}. Y represents an oxygen atom or a sulfur atom, and R^{g} represents a pyridyl group which may have one or more substituents.

In another preferred embodiment, the compound (I-1a) is a compound having a uracil ring structure. The uracil ring structure includes an imide structure. The compound (I-1a) having a uracil ring structure includes, for example, a compound represented by the following formula (I-1ab):

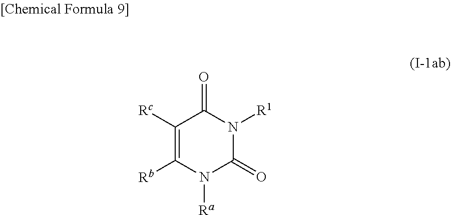

(hereinafter also referred to as “compound (I-1ab)”).

In formula (I-1ab), R¹, R^{a}, R^{b} and R^{c} are as defined above. R¹ is preferably an aryl group or heteroaryl group which may have one or more substituents, more preferably a phenyl group or pyridyl group which may have one or more substituents, still more preferably a phenyl group or 2-pyridyl group which may have one or more substituents. Examples of the substituent include a monovalent group which may contain one or more heteroatoms, a halogen atom and the like. The halogen atom is a fluorine atom, a chlorine atom, a bromine atom or an iodine atom, and preferably a fluorine atom or a chlorine atom.

R^{a} and R^{b} are preferably a monovalent group, more preferably an alkyl group or amino group which may be substituted with a halogen atom, still more preferably an alkyl group having 1 to 4 carbon atoms which may be substituted with a halogen atom, yet more preferably an alkyl group having 1 or 2 carbon atoms which may be substituted with a halogen atom, and particularly preferably a methyl group which may be substituted with a halogen atom. The halogen atom is a fluorine atom, a chlorine atom, a bromine atom or an iodine atom, and preferably a fluorine atom. In one embodiment, R^{a} is an alkyl group which is not substituted with a halogen atom, and R^{b} is a perfluoroalkyl group. Each of the number of carbon atoms of the alkyl group and the perfluoroalkyl group is preferably 1 to 4, more preferably 1 or 2, and still more preferably 1.

R^{c} is a hydrogen atom or an alkyl group, and preferably a hydrogen atom.

A preferred example of the compound (I-1ab) is preferably a compound in which R¹ is a phenyl group or pyridyl group which may have one or more substituents, R^{c} is a methyl group, and R¹ is a trifluoromethyl group.

The compound (I-1ab) includes, for example, a compound represented by the following formula (I-1ab′) (hereinafter referred to as “compound (I-1ab′)”).

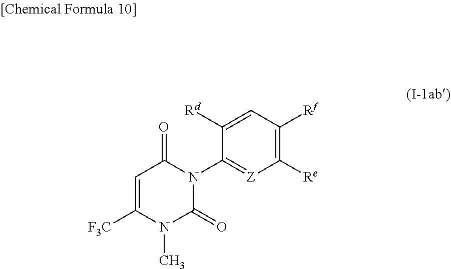

In formula (I-1ab′), R^{d}, R^{e} and R^{f} are the same as defined above. Specifically, R^{d} represents a fluorine atom or a hydrogen atom. R^{e} represents a monovalent group which may contain one or more heteroatoms. R^{f} represents a monovalent group which may contain one or more heteroatoms, or a halogen atom. R^{f} and R^{e} may be taken together to form a ring. Z represents C—H or N (nitrogen atom). The above halogen atom is a fluorine atom, a chlorine atom, a bromine atom or an iodine atom, and preferably a fluorine atom or a chlorine atom.

A preferred example of the monovalent group which may contain one or more heteroatoms as for R^{e} is —Y—R^{g}. Y represents an oxygen atom or a sulfur atom, and RU represents a pyridyl group which may have one or more substituents.

Specific example of the compound (I-1ab′) is a compound represented by the following formula (I-A) (hereinafter also referred to as “compound (I-A)”), and the compound is a PPO inhibitor.

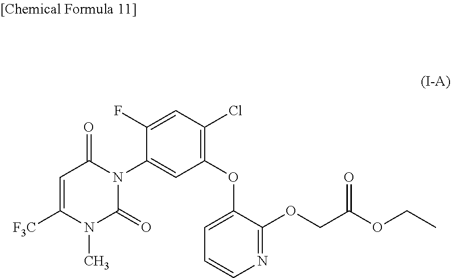 [SMILES: CCOC(=O)COc1ncccc1Oc1cc(-n2c(=O)cc(C(F)(F)F)n(C)c2=O)c(F)cc1Cl]

Examples of the compound (I-1aa) other than the compound having a uracil ring structure include a compound represented by the following formula (I-1aa′) (hereinafter also referred to as “compound (I-1aa′)”).

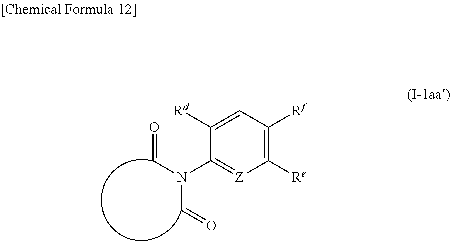

In formula (I-1aa′), a ring comprising an N atom represents a cyclic imide structure. R^{d}, R^{e} and R^{f} are as defined above. Specifically, R^{d} represents a fluorine atom or a hydrogen atom. R^{e} represents a monovalent group which may contain one or more heteroatoms. R^{f} represents a monovalent group which may contain one or more heteroatoms, or a halogen atom. R^{f} and R^{e} may be taken together to form a ring. Z represents C—H or N (nitrogen atom). The above halogen atom is a fluorine atom, a chlorine atom, a bromine atom or an iodine atom, and preferably a chlorine atom.

Examples of the cyclic imide structure include a succinimide structure, a glutalimide structure, a phthalimide structure, a tetrahydrophthalimide structure and the like.

A preferred example of the monovalent group which may contain one or more heteroatoms as for R^{e} is —Y—R^{g}. Y represents an oxygen atom or a sulfur atom, and R^{g} represents a pyridyl group which may have one or more substituents.

Specific examples of the compound (I-1aa′) are compounds represented by the following formulas (I-B) and (I-C) (hereinafter also referred to as “compounds (I-B) and (I-C)”, respectively), and these are both PPO inhibitors.

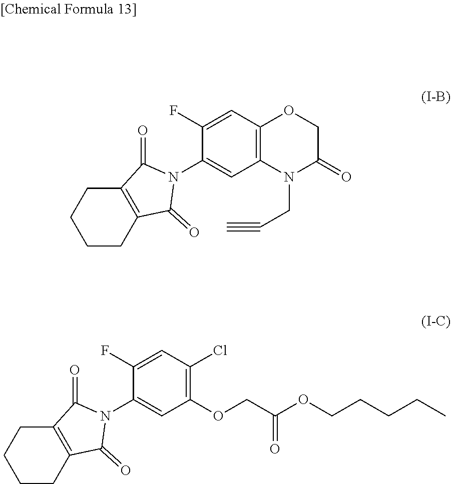 [SMILES: C#CCN1C(=O)COc2cc(F)c(N3C(=O)C4=C(CCCC4)C3=O)cc21 ; CCCCCOC(=O)COc1cc(N2C(=O)C3=C(CCCC3)C2=O)c(F)cc1Cl]

### [2-2] Compound Having Ester Structure

The compound having an ester structure (I-1) is a compound represented by the following formula (I-1b) (hereinafter also referred to as “compound (I-1b)”).

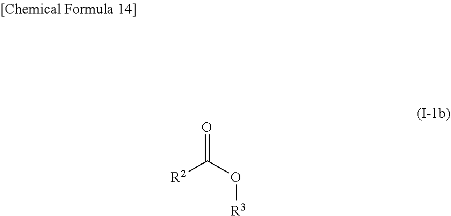

In formula (I-1b), R² and R³ are as defined above. The monovalent group represented by R² and R³ each independently include, for example, a monovalent aliphatic group, a monovalent aromatic group, a monovalent group comprising a combination of an aliphatic structure and an aromatic structure. Each of the monovalent aliphatic group, the monovalent aromatic group, and the monovalent group comprising a combination of an aliphatic structure and an aromatic structure may have one or more substituents, and may also contain one or more heteroatoms. The monovalent group represented by R² is preferably a monovalent group comprising a combination of an aliphatic structure and an aromatic structure. The monovalent group represented by R³ is preferably a monovalent aliphatic group, more preferably an alkyl group, still more preferably an alkyl group having 1 to 6 carbon atoms, and yet more preferably an alkyl group having 1 to 4 carbon atoms.

Each of the monovalent aliphatic group, the monovalent aromatic group, and the monovalent group comprising a combination of an aliphatic structure and an aromatic structure may have one or more substituents, or may also contain one or more heteroatoms. For example, one or more —CH₂-(s) included in these monovalent groups may be substituted with —O—, —S—, —C(═O)—, —C(═S)—, or —N(R)— [R represents a hydrogen atom or a monovalent group].

The compound (I-1b) includes, for example, a compound represented by the following formula (I-1ba) (hereinafter referred to as “compound (I-1ba)”).

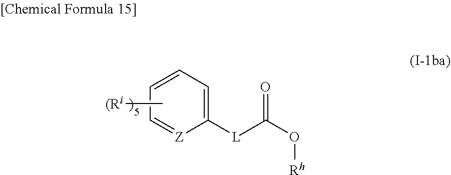

In formula (I-1ba), R^{h} represents an alkyl group. R^{h} is preferably an alkyl group having 1 to 6 carbon atoms, more preferably an alkyl group having 1 to 4 carbon atoms, and still more preferably an alkyl group having 1 or 2 carbon atoms. A plurality of Rⁱ(s) may be the same or different from each other, and each independently represent a hydrogen atom, a halogen atom, or a monovalent group which may contain one or more heteroatoms. L represents an alkylene group which may have a substituent. One or more —CH₂-(s) included in the alkylene group may be substituted with —O—, —S—, —C(═O)—, —C(═S)—, or —N(R)— [R represents a hydrogen atom or a monovalent group]. The number of carbon atoms of the alkylene group is, for example, 2 to 6, and preferably 2 or 3. Examples of the substituent, which may be possessed by the alkylene group, include a halogen atom. Z represents C—H or N (nitrogen atom).

A preferred example of the compound (I-1ba) is a compound represented by the following formula (I-1ba′) (hereinafter also referred to as “compound (I-1ba′)”).

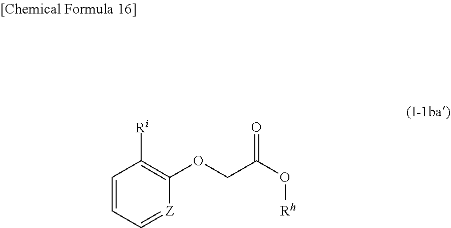

In formula (I-1ba′), R^{h} and Z are as defined above. R^{j} represents a monovalent group which may contain one or more heteroatoms.

Specific examples of the compound (I-1ba′) are the above-mentioned compound (I-A) and compound (I-C), and these are both PPO inhibitors.

When the total amount of the pesticidal composition is 100% by mass, the content of the compound (I) in the pesticidal composition is preferably 0.01% by mass or more and 25% by mass or less, more preferably 0.05% by mass or more and 20% by mass or less, still more preferably 0.1% by mass or more and 15% by mass or less, and yet more preferably 0.2% by mass or more and 10% by mass or less, in order to improve the storage stability of the pesticidal composition while appropriately increasing the content.

### [3] Other Pesticidal Active Ingredients

The pesticidal composition may comprise one or more pesticidal active compounds other than the auxin herbicide and the compound (I). Examples of the pesticidal active compounds other than the auxin herbicide and the compound (I) include, but are not particularly limited to, an insecticidal active ingredient, a fungicidal active ingredient, a herbicidal active ingredient, a plant growth regulation active ingredient and a phytotoxicity reduction active ingredient, of which a herbicidal active ingredient is preferable.

Examples of the herbicidal active compounds include protoporphyrinogen oxidase (PPO) inhibitors, acetyl CoA carboxylase (ACCase) inhibitors, acetolactate synthase (ALS) inhibitors, acetohydroxyacid synthase (AHAS) inhibitors, photosystem I inhibitors, photosystem II inhibitors, carotenoid biosynthesis inhibitors, enolpyruvyl shikimate 3-phosphate (EPSP) synthase inhibitors, glutamine synthetase inhibitors, dihydropteroate synthase inhibitors, mitosis inhibitors, nucleic acid inhibitors and the like.

When the total amount of the pesticidal active compound included in the pesticidal composition is 100% by mass, the total content of the auxin herbicide and the compound (I) in all the pesticidal active compounds included in the composition is, for example, 50% by mass or more and 100% by mass or less. The content is preferably 60% by mass or more and 100% by mass or less, more preferably 80% by mass or more and 100% by mass or less, still more preferably 90% by mass or more and 100% by mass or less, and particularly preferably 95% by mass or more and 100% by mass or less.

### [4] Polycarboxylic Acid and Salt Thereof

The pesticidal composition comprises at least one selected from the group consisting of a polycarboxylic acid and a salt thereof. As used herein, “polycarboxylic acid” means a compound having two or more carboxy groups in one molecule. Hereinafter, polycarboxylic acid and polycarboxylate are also collectively referred to as “polycarboxylic acids”. According to the pesticidal composition comprising polycarboxylic acids, it is possible to inhibit volatilization of the auxin herbicide and to inhibit decomposition of the compound (I). Meanwhile, when using a monocarboxylic acid or a salt thereof instead of polycarboxylic acids, it is possible to inhibit volatilization of the auxin herbicide, but it is impossible to inhibit decomposition of the compound (I). The pesticidal composition may comprise two or more polycarboxylic acids, two or more polycarboxylates, one or more polycarboxylic acids, and one or more polycarboxylates.

All carboxy groups of the polycarboxylate may be in a salt form, or some carboxy groups of the plurality of carboxy groups may be in a salt form. The salt form of the carboxy group is represented by the formula: —COO-M^{|}, where M^{|} is a cation. Examples of the polycarboxylate include alkali metal salts such as a sodium salt and a potassium salt, alkaline earth metal salts such as a magnesium salt and a calcium salt, and an amine salt.

The polycarboxylic acid and the polycarboxylate are preferably a polymer (including an oligomer). The polymer means a polymer of a monomer having one or more carboxy groups or —COO-M⁺ groups. Hereinafter, the polycarboxylic acid, which is a polymer, is also referred to as “polycarboxylic acid polymer”, and the polycarboxylate, which is a polymer, is also referred to as “polycarboxylate polymer”. The polycarboxylic acid polymer and the polycarboxylate polymer have two or more carboxy groups and/or —COO-M⁺ groups, and preferably ten or more groups. The number of carboxy groups and —COO-M⁺ groups possessed by the polycarboxylic acid polymer and the polycarboxylate polymer depends on the molecular weight (degree of polymerization) of the polymer.

The polycarboxylic acid polymer and the polycarboxylate polymer may be either a homopolymer of a monomer having carboxy groups or —COO-M⁺ groups, or a copolymer of a monomer having carboxy groups or —COO⁻M⁺ groups and other monomers copolymerizable with the monomer. The polycarboxylic acid polymer and the polycarboxylate polymer are preferably water soluble.

Examples of the monomer having carboxy groups or —COO⁻M^{|} groups include unsaturated monocarboxylic acids such as acrylic acid, methacrylic acid, crotonic acid, and o-, m- and p-vinylbenzoic acid; unsaturated dicarboxylic acids such as maleic acid, fumaric acid, citraconic acid, mesaconic acid, itaconic acid, 3-vinylphthalic acid, 4-vinylphthalic acid, 3,4,5,6-tetrahydrophthalic acid, 1,2,3,6-tetrahydrophthalic acid, dimethyltetrahydrophthalic acid and 1,4-cyclohexenedicarboxylic acid; and salts thereof. The polycarboxylic acid polymer and the polycarboxylate polymer can include two or more constituent units derived from a monomer having carboxy groups or —COO-M⁺ groups.

Examples of other monomers mentioned above include acrylic acid ester, methacrylic acid ester, vinyl alcohol, acrylamide and the like. The polycarboxylic acid polymer and the polycarboxylate polymer can include two or more constituent units derived from other monomers.

Examples of the polycarboxylic acid polymer and the polycarboxylate polymer include polyacrylic acid, polymethacrylic acid, alkali metal salts (sodium salt, potassium salt, etc.) of polyacrylic acid or polymethacrylic acid, acrylic acid-maleic acid copolymer, methacrylic acid-maleic acid copolymer, acrylic acid-maleic acid copolymer or alkali metal salts (sodium salt, potassium salt, etc.) of acrylic acid-maleic acid copolymer and the like.

The molecular weight (Mw) of the polycarboxylic acid polymer and the polycarboxylate polymer is preferably 200 or more, more preferably 500 or more, still more preferably 1,000 or more, yet more preferably 1,200 or more, further preferably 1,500 or more, still further preferably 2,000 or more, particularly preferably 2,500 or more, and most preferably 4,000 or more. When Mw is within the above range, it is possible to effectively inhibit decomposition of the compound (I). Mw is preferably 250,000 or less, more preferably 200,000 or less, still more preferably 150,000 or less, yet more preferably 100,000 or less, further preferably 75,000 or less, still further preferably 50,000 or less, particularly 30,000 or less, and most preferably 25,000 or less. When Mw is within the above range, the polycarboxylic acid polymer and the polycarboxylate polymer easily become water soluble, and as a result, it becomes easier to prepare a formulation.

When the auxin herbicide included in the pesticidal composition is a dicamba amine salt, the content of polycarboxylic acids in the pesticidal composition is preferably 0.1 mol or more and 10 mol or less, more preferably 0.2 mol or more and 8 mol or less, still more preferably 0.3 mol or more and 6 mol or less, yet more preferably 0.4 mol or more and 4 mol or less, and particularly preferably 0.5 mol or more and 2 mol or less, based on 1 mol of dicamba acid, when the amount of the dicamba amine salt is expressed by the amount of dicamba acid constituting the dicamba amine salt, and the amount of the polycarboxylic acids is expressed as the amount of one molecule of monocarboxylic acid constituting the polycarboxylic acids. When the content of polycarboxylic acids is within the above range, it is possible to effectively inhibit decomposition of the compound (I) while moderately inhibiting the volatility of dicamba.

### [5] Basic Component

The pesticidal composition may further comprise a basic component. The basic component can function as a pH adjuster to adjust the pH of the pesticidal composition. The basic component is preferably water soluble. The pesticidal composition may comprise two or more basic components. The basic component as used herein does not include the above-mentioned polycarboxylates which exhibit the basicity.

Examples of the basic components include organic bases such as diglycolamine, monoethanolamine and polyethyleneimine; and inorganic bases. The basic component is preferably an inorganic base, and more preferably an alkali metal salt. Examples of the alkali metal salts include alkali metal hydroxides, alkali metal carbonates and alkali metal bicarbonates. Of these, the basic component is preferably an alkali metal hydroxide. Examples of the alkali metal hydroxides include lithium hydroxide, sodium hydroxide, potassium hydroxide and the like, of which and sodium hydroxide and potassium hydroxide are preferable. When the pesticidal composition further comprises a basic component, it is preferred that the pesticidal composition comprises at least one alkali metal hydroxide selected from the group consisting of potassium hydroxide and sodium hydroxide.

The content of the basic component in the pesticidal composition is preferably adjusted in consideration of the pH value of the pesticidal composition. The pH value at 25° C. of the pesticidal composition is preferably 4.0 or more and 9.0 or less, more preferably 4.2 or more and 8.5 or less, still more preferably 4.4 or more and 8.0 or less, yet more preferably 4.6 or more and 7.5 or less, further preferably 4.7 or more and 7.0 or less, still further preferably 4.8 or more and 6.5 or less, still more further preferably 4.9 or more and 6.0 or less, and most preferably 5.0 or more and 5.8 or less. When the pH value at 25° C. of the pesticidal composition is within the above range, it is possible to more effectively inhibit decomposition of the compound (I). The pH value of the pesticidal composition can be measured by charging the pesticidal composition in a glass container, shaking the glass container by hand, and dipping an electrode of a pH meter in the pesticidal composition.

The content of the basic component in the pesticidal composition is preferably the amount such that the pH value at 25° C. of the pesticidal composition is within the above range. The concentration of the basic component in the pesticidal composition is, for example, 0.0001 mol/L or more and 0.050 mol/L or less, preferably 0.0005 mol/L or more and 0.040 mol/L or less, more preferably 0.00075 mol/L or more and 0.030 mol/L or less, still more preferably 0.001 mol/L or more and 0.025 mol/L or less, and yet more preferably 0.002 mol/L or more and 0.020 mol/L or less.

The pesticidal composition may comprise no basic component. An example of the pesticidal composition comprising no basic component is a pesticidal composition in which the pH value at 25° C. of the pesticidal composition is adjusted within the above range by the inclusion of polycarboxylic acids. For example, use of polycarboxylic acid and polycarboxylate in combination as polycarboxylic acids enables adjustment of the pH value at 25° C. of the pesticidal composition within the above range without further inclusion of the basic component.

### [6] Organic Solvent

The pesticidal composition can comprise an organic solvent. The organic solvent constitutes the above oil phase. The organic solvent is preferably an organic solvent capable of dissolving the compound (I). The pesticidal composition can comprise one or more organic solvents.

The organic solvent preferably has water solubility at 25° C. of 10% by mass or less. The water solubility may be 8% by mass or less, 5% by mass or less, 3% by mass or less, or 1% by mass or less. It is preferable for the pesticidal composition to comprise an organic solvent having water solubility within the above range because the storage stability of the pesticidal composition is improved. The water solubility at 25° C. of the organic solvent is usually 0% by mass or more, and may be 10-5% by mass or more.

As used herein, the water solubility at 25° C. refers to the solubility in water at a temperature of 25° C. and a pH of 7. For example, the solubility of 10% by mass in water at 25° C. means the solubility of 1×10⁻¹ g in 1 g of water at a temperature of 25° C. and a pH of 7.

It is possible to adopt, as the water solubility of the organic solvent, the numerical value listed in the database (Solubility Database) of the International Union of Pure and Applied Chemistry (IUPAC) or the National Institute of Standards and Technology (NIST) of the United States. If not listed in the database, the water solubility of the organic solvent can be measured by quantifying the saturated solubility in water at a temperature of 25° C. and a pH of 7 using high-performance liquid chromatography.

Examples of the organic solvent capable of dissolving the compound (I) include:
alcohols such as butanol, amyl alcohol, hexanol, heptanol, octanol, 2-ethylhexanol, cyclohexanol and benzyl alcohol;
esters such as acetic acid esters (for example, ethyl acetate, butyl acetate, isoamyl acetate, isobornyl acetate, hexyl acetate, heptyl acetate, octyl acetate, benzyl acetate), carbonic acid esters (for example, diethyl carbonate, dibutyl carbonate), fatty acid esters (for example, isopropyl myristate, methyl octanoate, methyl oleate, methyl laurate, dimethyl adipate, dibutyl adipate, didecyl adipate, tri-n-butyl citrate, di-n-butyl phthalate, methyl caprylate, methyl laurate, methyl myristate, methyl salicylate, methyl palmitate, methyl oleate, ethyl palmitate), phthalic acid esters (for example, dimethyl phthalate, diethyl phthalate), benzoic acid esters (for example, methyl benzoate, ethyl benzoate), succinic acid esters (for example, dioctyl succinate) and acetoacetic acid esters (for example, tert-butyl acetoacetate, allyl acetoacetate);
ethers such as propylene glycol phenyl ether;
ketones such as cyclohexanone, 2-heptanone, isophorone, mesityl oxide, methyl isoamyl ketone, methyl isobutyl ketone, acetophenone, methylcyclohexanone and acetophenone;
amides such as fatty acid dimethylamides (for example, N,N-dimethyloctanamide, N,N-dimethyldecanamide, N,N-dimethyldodecanamide, N,N-dimethyltetradecanamide, N,N-dimethyloctadecanamide) and alkylpyrrolidones (for example, N-octyl-pyrrolidone, N-dodecyl-pyrrolidone, N-decyl-pyrrolidone);
lactones such as γ-octanolactone and δ-octanolactone;
amines such as n-octylamine, oleylamine and laurylamine;
aliphatic hydrocarbons such as decane, tridecane, tetradecane, hexadecane, octadecane, normal paraffin, isoparaffin, cycloparaffin, 1-undecene and 1-heneicosene;
aromatic hydrocarbons, for example, alkylbenzenes such as toluene, xylene, ethylbenzene, octadecylbenzene, dialkylbenzene and trialkylbenzene, alkylnaphthalenes such as methylnaphthalene, dimethylnaphthalene, dodecylnaphthalene and tridecylnaphthalene, and phenylxylylethane and 1-phenyl-1-ethylphenylethane, and mixtures thereof;
fatty acids such as oleic acid, capric acid and enanthic acid;
animal and vegetable oils, such as coconut oil, olive oil, soybean oil, rapeseed oil, castor oil, linseed oil, cottonseed oil, palm oil, avocado oil and shark liver oil, sardine oil and saury oil;
mineral oils such as naphtha, petroleum ether, kerosene, diesel oil, paraffin, olefin and machine oil; and
silicone oil.

From the viewpoint of the solubility of the compound (I) and the storage stability of the pesticidal composition, the organic solvent preferably includes one or more types selected from the group consisting of aromatic hydrocarbons, aliphatic hydrocarbons, ketones, esters, ethers, amides, amines and alcohols, and more preferably aromatic hydrocarbons. The aromatic hydrocarbon preferably includes one or more types selected from the group consisting of alkylbenzenes (for example, toluene, xylene, ethylbenzene, octadecylbenzene, dialkylbenzene and trialkylbenzene), alkylnaphthalenes (for example, methylnaphthalene, dimethylnaphthalene, dodecylnaphthalene and tridecylnaphthalene), phenyl xylyl ethane and 1-phenyl-1-ethylphenylethane, more preferably one or more types selected from the group consisting of alkylbenzenes and alkylnaphthalenes, and still more preferably one or more types selected from the group consisting of C9-C12 alkylbenzenes and C10-C15 alkylnaphthalenes. The organic solvent may be composed of an aromatic hydrocarbon.

When the total amount of the pesticidal composition is 100% by mass, the content of the organic solvent in the pesticidal composition is preferably 0.1% by mass or more and 45% by mass or less, more preferably 0.5% by mass or more and 40% by mass or less, still more preferably 1% by mass or more and 35% by mass or less, and yet more preferably 3% by mass or more and 30% by mass or less. It is preferable for the pesticidal composition to comprise the organic solvent in the content within the above range from the viewpoint of improving the storage stability of the pesticidal composition while moderately increasing the content of the compound (I).

The content of the organic solvent is usually 1 mass times or more and 50 mass times or less, preferably 2 mass times or more and 40 mass times or less, more preferably 3 mass times or more and 30 mass times or less, still more preferably 4 mass times or more and 25 mass times or less, yet more preferably 5 mass times or more and 20 mass times or less, further preferably 6 mass times or more and 20 mass times or less, still further preferably 7 mass times or more and 20 mass times or less, and particularly preferably 8 mass times or more and 20 mass times or less, the content of the compound (I). It is preferable to adjust the ratio (mass ratio) of the content of the organic solvent to the content of the compound (I) within the above range from the viewpoint of improving the storage stability of the pesticidal composition while moderately increasing the content of the compound (I).

### [7] Water

The pesticidal composition can comprise water. Examples of water include ion-exchanged water, tap water and underground water. Water constitutes the above aqueous phase of the pesticidal composition.

When the total amount of the pesticidal composition is 100% by mass, the content of water in the pesticidal composition is preferably 30% by mass or more and 95% by mass or less, more preferably 35% by mass or more and 90% by mass or less, still more preferably 40% by mass or more and 80% by mass or less, and yet more preferably 45% by mass or more and 75% by mass or less. It is preferable for the pesticidal composition to comprise water in the content within the above range from the viewpoint of improving the suspended or emulsified state of the pesticidal composition.

### [8] Other Ingredients

The pesticidal composition may comprise an auxiliary agent for formulation. Examples of the auxiliary agents for formulation include surfactants, thickeners, defoamers, anti-freezing agents, preservatives and the like.

Examples of the surfactants include nonionic surfactants, anionic surfactants, cationic surfactants and amphoteric surfactants. The pesticidal composition can comprise one or more surfactants selected from the group consisting of nonionic surfactants, anionic surfactants, cationic surfactants and amphoteric surfactants.

Examples of the nonionic surfactants include:
block polymers such as polyoxyethylene-polyoxypropylene block copolymers, and block polymers of alkanol, polyethylene oxide and polypropylene oxide;
synthetic polymers such as vinyl acetate copolymers, polymethacrylic acid and copolymers of methacrylic acid and methacrylic acid esters;
polyoxyalkylene fatty acid esters such as polyoxyethylene fatty acid esters (for example, polyoxyethylene stearic acid ester), polyoxypropylene fatty acid esters (for example, polyoxypropylene stearic acid ester) and polyoxyethylene polyoxypropylene fatty acid esters;
fatty acid esters such as fatty acid esters of polyols, monoglycerides and phospholipids;
alcohol ethoxylates such as aliphatic alcohol ethoxylates (for example, tridecyl alcohol ethoxylate, isooctyl alcohol ethoxylate, lauryl alcohol ethoxylate, hexadecyl alcohol ethoxylate, stearyl alcohol ethoxylate), alkylphenol ethoxylates (for example, nonylphenol ethoxylate, tristillylphenol ethoxylate, tributylphenol ethoxylate, octylphenol ethoxylate), arylalkylphenol ethoxylates and arylphenol ethoxylates (for example, monobenzylbiphenol alcohol ethoxylate);
alcohol provoxylates such as aliphatic alcohol provoxylates, alkylphenol provoxylates and arylalkylphenol provoxylates;
polyoxyethylene vegetable oils such as polyoxyethylene castor oil and polyoxyethylene polyoxypropylene castor oil; polyoxyalkylene hydrogenated vegetable oils such as polyoxyethylene hydrogenated castor oil;
glycerin fatty acid esters;
glucose esters;
cellulose esters;
sucrose fatty acid esters (for example, sucrose stearic acid diester);
polyvinyl alcohol;
sorbitan fatty acid esters (for example, sorbitan laurate, sorbitan stearate, sorbitan oleate and sorbitan trioleate);
polyoxyalkylene sorbitan fatty acid esters (for example, polyoxyethylene sorbitan laurate, polyoxyethylene sorbitan stearate, polyoxyethylene sorbitan oleate and polyoxyethylene sorbitan trioleate);
fatty acid amine esters such as polyoxyethylene fatty acid amine esters and polyoxypropylene fatty acid amine esters;
polyoxyethylene rosin esters;
amides such as fatty acid alkanolamides (for example, diethanolamide laurate), alkoxylated propylene oxide fatty acid glucamides, polyoxyethylene oleic acid amides, polyoxyethylene stearic acid amides and polyvinylpyrrolidone; and
amines such as alkoxylated amines (for example, polyoxyethylene oleylamine, α,α′-[(9-octadecenylimino)di2,1-ethanedyl]bis(ω-hydroxy)poly(oxyethylene)].

Examples of the anionic surfactants include:
sulfonates such as alkyl sulfonates (for example, dodecyl sulfonate), alpha-olefin sulfonates, alkyl benzene sulfonates (for example, decyl benzene sulfonate, dodecyl benzene sulfonate, tridecyl benzene sulfonate, diphenyl sulfonate), alkyl naphthalene sulfonates (for example, naphthalene sulfonate, dibutylnaphthalene sulfonate, 2,2′-dinaphthylmethane-6,6′-disulfonate, diisopropylnaphthalene sulfonate, triisopropylnaphthalene sulfonate), dialkylsulfosuccinates (for example, sodium di(2-ethylhexyl)sulfosuccinate), N-methyl-N-acyl taurates (for example, oleoyl methyl taurate), other lignin sulfonates, alkylphenol sulfonates and derivatives thereof, naphthalene sulfonates-formaldehyde fused products and derivatives thereof, and benzimidazole sulfonic acid derivatives;
sulfuric acid ester salts such as alkyl sulfates (for example, n-hexyl sulfate, n-heptyl sulfate, lauryl sulfate, lauryl sulfate diethanol salt, octadecyl sulfate), polyoxyethylene alkyl ether sulfates (for example, laureth-3-sulfate), polyoxypropylene alkyl ether sulfates, and polyoxyethylene distyryl phenyl ether sulfates;
carboxylates, for example, fatty acid salts such as octanoate, decanoate, laurate, myristate, palmitate, stearate, behenate and oleate and derivatives thereof, ether carboxylates such as laureth-3-carboxylate and derivatives thereof, N-acylsarcosine salts such as N-lauroylsarcosine salt and derivatives thereof, N-acylglutamates such as N-lauroylglutamate and derivatives thereof, and polycarboxylates such as comb-shaped polymers of polyacrylates, polyvinyl acetates and polyacid salts and derivatives thereof; and
phosphoric acid esters, for example, alkyl phosphates such as lauryl phosphate and derivatives thereof, polyoxyethylene alkyl ether phosphates and derivatives thereof, polyoxyethylene alkyl phenyl ether phosphates and derivatives thereof, and polyoxypropylene alkyl ether phosphates and derivatives thereof.

Examples of salts in the above sulfonates, sulfates, carboxylates and phosphates include sodium salts, potassium salts, calcium salts, ammonium salts, isopropylamine salts, triethanolamine salts and the like.

Examples of the cationic surfactants include:
alkyl amine salts such as monomethylamine salts, dimethylamine salts, trimethylamine salts and dodecylamine salts;
fatty acid amide amine salts such as stearamidopropyl dimethylamine and behenamidopropyl dimethylamine;
polyamine salts such as polyvinylamine and polyethyleneimine; and
alkyl quaternary ammonium salts such as lauryl trimethyl ammonium salts, cetyltrimethyl ammonium salts, dodecyl trimethyl ammonium salts, stearyl methyl ammonium salts, benzylbis(2-chloroethyl)ethylammonium bromide salts, alkyl dimethylbenzyl ammonium salts, alkyl pyridinium salts, alkylpyridinium salts, alkylisoquinolinium salts and dialkylmorpholinium salts.

Examples of the amphoteric surfactants include N-laurylalanine, N,N,N-trimethylaminopropionic acid, N,N,N-trihydroxyethylaminopropionic acid, N-hexyl-N,N-dimethylaminoacetic acid, betaine, alkyl betaines (for example, 1-(2-carboxyethyl)pyrimidinium betaine), imidazoline, taurine, alkyl taurine and lecithin.

From the viewpoint of improving the suspended or emulsified state of the pesticidal composition, when the total amount of the pesticidal composition is 100% by mass, the content of the surfactant in the pesticidal composition is preferably 0.5% by mass or more and 30% by mass or less, more preferably 0.7% by mass or more and 25% by mass or less, still more preferably 0.8% by mass or more and 20% by mass or less, yet more preferably 1% by mass or more and 15% by mass or less, and particularly preferably 1.5% by mass or more and 10% by mass or less.

The content of the surfactant is preferably 0.05 mass times or more and 30 mass times or less, more preferably 0.07 mass times or more and 25 mass times or less, still more preferably 0.1 mass times or more and 20 mass times or less, and particularly preferably 0.1 mass times or more and 15 mass times or less, the content of the pesticidal active compound.

Examples of the thickeners include polysaccharides such as xanthan gum, guar gum, Welan gum, Diutan gum and cellulose nanofiber, clay, silicates and the like. When the total amount of the pesticidal composition is 100% by mass, the content of the thickener in the pesticidal composition is usually 0.01% by mass or more and may be 0.05% by mass or more or 0.1% by mass or more, and is usually 5% or less and may be 3% by mass or less.

Examples of the defoamers include silicone-based defoamers. When the total amount of the pesticidal composition is 100% by mass, the content of the defoamer in the pesticidal composition is usually 0.01% by mass or more and may be 0.05% by mass or more or 0.1% by mass or more, and is usually 1% by mass or less and may be 0.5% by mass or less.

Examples of the anti-freezing agents include ethylene glycol, propylene glycol, urea, glycerin and the like. When the total amount of the pesticidal composition is 100% by mass, the content of the anti-freezing agent in the pesticidal composition is usually 1% by mass or more and may be 2% by mass or more, and is usually 10% by mass or less or may be 8% by mass or less.

Examples of the preservatives include isothiazolinone preservatives. When the total amount of the pesticidal composition is 100% by mass, the content of the preservative in the pesticidal composition is usually 0.05% by mass or more and may be 0.1% by mass or more, and is usually 0.5% by mass or less and may be 0.3% by mass or less.

### <Preparation of Liquid Pesticidal Composition>

It is possible to prepare a pesticidal composition in which a dicamba amine salt is contained in an aqueous phase and the compound (I) is suspended in an aqueous phase, for example, in the following manner. The dicamba amine salt, the compound (I), water, a surfactant and, if necessary, an auxiliary agent for formulation are ground and suspended by a wet grinding method using media such as glass beads or zirconia to obtain a suspension. The suspension does not have to contain the dicamba amine salt. If not, the resulting suspension is mixed with the dicamba amine salt to obtain a mixture. The suspension or mixture is mixed with polycarboxylic acids and, if necessary, the auxiliary agent for formulation, such as a thickener, a preservative or a defoamer to obtain a pesticidal composition.

It is possible to prepare a pesticidal composition which is an oil-in-water emulsion containing a dicamba amine salt in an aqueous phase and the compound (I) in an oil phase, for example, in the following manner. The compound (I), an organic solvent and, if necessary, a surfactant are mixed to prepare an oil phase. Meanwhile, the dicamba amine salt, an auxiliary agent for formulation, water and, if necessary, a surfactant are added to prepare an aqueous phase. The surfactant may be added to the organic solvent or water, or may be added to both. The oil phase is added to the aqueous phase, followed by emulsification with a stirrer such as a homogenizer to obtain an emulsion. The emulsion is mixed with polycarboxylic acids and, if necessary, a basic component and an auxiliary agent for formulation, such as a thickener, a preservative or a defoamer to obtain a pesticidal composition.

It is possible to prepare a pesticidal composition which is an oil-in-water emulsion containing a dicamba amine salt in an aqueous phase, the compound (I) (first compound (I)) suspended in an aqueous phase and the other compound (I) (second compound (I)) in an oil phase, for example, in the following manner. The second compound (I), an organic solvent and, if necessary, a surfactant are mixed to prepare an oil phase. Meanwhile, the dicamba amine salt, an auxiliary agent for formulation, water and, if necessary, a surfactant are added to prepare an aqueous phase. The surfactant may be added to the organic solvent or water, or may be added to both. Further, the first compound (I), water, a surfactant, and, if necessary, other auxiliary agent for formulation are ground and suspended by a wet grinding method using media such as glass beads or zirconia to obtain a suspension. The oil phase is added to the aqueous phase, followed by emulsification with a stirrer such as a homogenizer to obtain an emulsion. The emulsion is mixed with the suspension, polycarboxylic acids and, if necessary, a basic component and an auxiliary agent for formulation, such as a thickener, a preservative or a defoamer to obtain a pesticidal composition.

### <Use of Liquid Pesticidal Composition>

It is possible to suitably use the pesticidal composition as a liquid pesticidal formulation called suspension concentrate (SC), emulsifiable concentrate (EC), emulsion oil in water (EW), suspoemulsion (SE), microemulsion (ME), microcapsule (MC) or soluble concentrate (SL) in the field of pesticides.

The pesticidal composition is capable of controlling weeds by use in agricultural lands such as fields, orchards, pastures, lawns and forestry lands; and non-crop areas such as bank slopes, riverbeds, road shoulders and slopes, railroad beds, parks, grounds, parking lots, airports, industrial sites such as factories and storage facilities, fallow lands and idle lands in urban areas.

The user usually mixes the pesticidal composition with water to prepare a suspension or emulsion, which is then sprayed with a knapsack sprayer, a spray tank, a spray plane, or an irrigation system. The spray volume varies depending on the climatic conditions, treatment time, soil conditions, target crops, target weeds and the like, but is usually 10 L or more and 2,000 L or less, and preferably 50 L or more and 400 L or less, per hectare. The suspension or emulsion is prepared by mixing the suspension or emulsion with water, which is usually 2 to 10,000 times, preferably 10 to 8,000 times, and more preferably 15 to 6,000 times, the volume of the suspension or emulsion, respectively.

When the suspension or emulsion is applied, an adjuvant may be used in combination. Although there is no particular limitation on type of the adjuvant, in the case of oil-based adjuvants such as Agri-Dex and MSO (mineral oils such as paraffinic hydrocarbons, naphthenic hydrocarbons, aromatic hydrocarbons, or Methylated Seed Oil obtained by esterifying vegetable oils (soybean oil or rapeseed oil)), 0.25%, 0.5%, 1%, 2%, 3%, 4%, 5% or 6% (volume/volume) of the adjuvants are preferably mixed in the spray liquid. In the case of nonionic adjuvants such as Induce (polyoxyalkylene alkyl ethers, polyoxyalkylene fatty acid esters, alkyl aryl alkoxylates or alkyl aryl polyoxyalkylene glycols), 0.05%, 0.1%, 0.25% or 0.5% (volume/volume) of the adjuvants are preferably mixed in the spray liquid. It is possible to exemplify anionic adjuvants (substituted sulfonates) such as Gramine S, cationic adjuvants (polyoxyethylene amines) such as Genamin T 200BM, and organosilicone-based adjuvants such as Silwet L77. It is also possible to mix drift reducers such as Intact (polyethylene glycol), and/or volatilization reducers such as Vapex and a VaporGrip Xtra Agent (mixture of potassium hydroxide and acetic acid). There is no particular limitation on pH and hardness of the above spray liquid.

### EXAMPLES

Hereinafter, the present invention will be described in more detail by way of Examples, Comparative Examples and the like, but the present invention is not limited by these Examples.

Ingredients used in the preparation of the liquid pesticidal compositions are shown below.

### [1] Dicamba Amine Salt

Dicamba-DGA: Dicamba diglycolamine salt (an aqueous 59.0% by mass (39.5% by mass as dicamba acid) solution of the salt was used in the preparation of the liquid pesticidal composition. The amounts shown in Table 1 and table 2 are the amounts as dicamba acid)
Dicamba-MEA: Dicamba monoethanolamine salt (an aqueous 71.6% by mass (56.0% by mass as dicamba acid) solution of the salt was used in the preparation of the liquid pesticidal composition. The amounts shown in Table 1 and Table 2 are the amounts as dicamba acid)

### [2] Compound (I)

Compound (I-A) represented by the above formula (I-A)
Compound (I-B) represented by the above formula (I-B)
Compound (I-C) represented by the above formula (I-C)

### [3] Organic Solvent

Solvesso 200ND: C₁₀-C₁₃ alkylnaphthalenes, mainly as aromatic hydrocarbon, manufactured by Exxon Mobil Corporation

### [4] Surfactant

Pluronic P-104: polyoxyethylene polyoxypropylene block copolymer, manufactured by BASF Corporation
Reax 910: sodium lignin sulfonate, manufactured by Ingevity Corporation
Synperonic PE/F 127: polyoxyethylene polyoxypropylene block copolymer, manufactured by Croda
Selvol 523: polyvinyl alcohol, manufactured by SEKISUI CHEMICAL CO., LTD.

### [5] Thickener

Kelzan AP-AS: Xanthan gum, manufactured by CP Kelco
Veegum R: magnesium aluminum silicate, manufactured by R. T. Vanderbilt Company. Inc.

### [6] Defoamer

XIAMETER ACP-1500: silicone-based mixture, manufactured byDow Corning Toray Co., Ltd.

### [7] Preservative

Proxel GXL: 1,2-benzoisothiazolin-3-one, manufactured by Lonza

### [8] Other Additives

NaCl: sodium chloride (Special Grade), manufactured by FUJIFILM Wako Pure Chemical Corporation

### [9] Acid or Salt Thereof

Acetic acid: acetic acid (Special Grade), manufactured by FUJIFILM Wako Pure Chemical Corporation
Propionic acid: propionic acid (Wako Special Grade), manufactured by FUJIFILM Wako Pure Chemical Corporation
Polyacrylic acid 5,000: polyacrylic acid (Wako 1st Grade), manufactured by FUJIFILM Wako Pure Chemical Corporation, solid content: 100% by mass, weight-average molecular weight: 5,000
Polyacrylic acid 25,000: polyacrylic acid (Wako 1st Grade), manufactured by FUJIFILM Wako Pure Chemical Corporation, solid content: 100% by mass, weight-average molecular weight: 25,000
AQUALIC TL-37: acrylic acid-maleic acid copolymer sodium salt, manufactured by NIPPON SHOKUBAI CO., LTD., solid content: 37% by mass, weight-average molecular weight: 5,000

### [10] Basic Component

Potassium hydroxide: potassium hydroxide (purity: 85%, reagent special grade), manufactured by FUJIFILM Wako Pure Chemicals Co. The amounts shown in Table 1 and Table 2 are values in term of pure content.
Sodium hydroxide: sodium hydroxide (purity: 97%, Reagent Grade Special), manufactured by FUJIFILM Wako Pure Chemicals Co. The amounts shown in Table 1 and Table 2 are values in term of pure content.

### <Preparation of Emulsion (A1) of Pesticidal Active Compound Containing Dicamba DGA>

0.53 Part by mass of the compound (I-A) and 1.00 parts by mass of Pluronic P-104 were mixed with 5.25 parts by mass of Solvesso 200ND to prepare 6.775 parts by mass of an oil phase. To a mixed solution of 37.21 parts by mass of an aqueous Dicamba DGA solution (concentration of dicamba acid: 39.5% by mass) and 0.067 part by mass of XIAMETER ACP-1500, the above oil phase was added, and then the mixture was emulsified by stirring using a Polytron homogenizer (manufactured by KINEMATICA AG) to obtain 44.06 parts by mass of an emulsion (A1) of a pesticidal active compound.

<Preparation of Emulsion (A2) of Pesticidal Active Compound containing Dicamba MEA>

0.53 Part by mass of the compound (I-A) and 1.00 parts by mass of Pluronic P-104 were mixed with 5.25 parts by mass of Solvesso 200ND to prepare 6.775 parts by mass of an oil phase. To a mixed solution of 26.25 parts by mass of an aqueous Dicamba MEA solution (concentration of dicamba acid: 56.0% by mass) and 0.067 part by mass of XIAMETER ACP-1500, the above oil phase was added, and then the mixture was emulsified by stirring using a Polytron homogenizer (manufactured by KINEMATICA AG) to obtain 33.10 parts by mass of an emulsion (A2) of a pesticidal active compound.

### <Preparation of Emulsion (A3) of Pesticidal Active Compound Containing Dicamba DGA>

0.53 Part by mass of the compound (I-A) was mixed with 5.25 parts by mass of Solvesso 200ND to prepare 5.775 parts by mass of an oil phase. To a mixed solution of 37.21 parts by mass of an aqueous Dicamba DGA solution (concentration of dicamba acid: 39.5% by mass), 0.067 part by mass of XIAMETER ACP-1500 and 3.89 parts by mass of an aqueous Selvol 523 solution (concentration of Selvol 523: 9% by mass), the above oil phase was added, and then the mixture was emulsified by stirring using a Polytron homogenizer (manufactured by KINEMATICA AG) to obtain 46.95 parts by mass of an emulsion (A3) of a pesticidal active compound.

### <Preparation of Suspension (B1) of Pesticidal Active Compound Containing Compound (I-B)>

To 14.72 parts by mass of ion-exchanged water, 0.40 part by mass of Veegum R, 0.067 part by mass of XIAMETER ACP-1500, 4.00 parts by mass of Reax910, 0.50 part by mass of Synperonic PE/F 127 and 2.28 parts by mass of the compound (I-B) were added, and after stirring and mixing, the mixture was wet-ground using a bead mill (product name: DYNO-MILL, manufactured by SHINMARU ENTERPRISES CORPORATION, glass bead diameter: 1.0 mm, filling rate: 80%, peripheral speed: 10 m/s) to obtain 21.97 parts by mass of a suspension (B1) of a pesticidal active compound.

### <Preparation of Suspension (B2) of Pesticidal Active Compound Containing Compound (I-C)>

To 14.72 parts by mass of ion-exchanged water, 0.40 part by mass of Veegum R, 0.067 part by mass of XIAMETER ACP-1500, 4.00 parts by mass of Reax910, 0.50 part by mass of Synperonic PE/F 127 and 2.28 parts by mass of the compound (I-C) were added, and after stirring and mixing, the mixture was wet-ground using a bead mill (product name: Awatori Neritaro ARE-310, manufactured by THINKY CORPORATION) to obtain 21.97 parts by mass of a suspension (B2) of a pesticidal active compound.

### <Preparation of Thickener-Containing Liquid (C1)>

0.20 part by mass of Kelzan AP-AS, 0.20 part by mass of Proxel GXL and 20.00 parts by mass of ion-exchanged water were mixed to obtain 20.40 parts by mass of a thickener-containing liquid (C1).

### <Preparation of Thickener-Containing Liquid (C2)>

20.40 Parts by mass of the thickener-containing liquid (C1) was obtained according to the above manner. To 20.40 parts by mass of the thickener-containing liquid (C1) thus obtained, 4.15 parts by mass of sodium chloride was added and then dissolved by stirring and mixing to obtain 24.55 parts by mass of a thickener-containing liquid (C2).

### <Preparation of Premixture (D1)>

44.06 Parts by mass of the emulsion (A1) of the pesticidal active compound, 21.97 parts by mass of the suspension (B1) of the pesticidal active compound, 20.40 parts by mass of the thickener-containing liquid (C1) and 0.067 parts by mass of XIAMETER ACP-1500 were stirred and mixed to obtain 86.50 parts by mass of a premixture (D1).

### <Preparation of Premixture (D2)>

44.06 Parts by mass of the emulsion (A1) of the pesticidal active compound, 21.97 parts by mass of the suspension (B1) of the pesticidal active compound, 24.55 parts by mass of the thickener-containing liquid (C2) and 0.067 parts by mass of XIAMETER ACP-1500 were stirred and mixed to obtain 90.65 parts by mass of a premixture (D2).

### <Preparation of Premixture (D3)>

33.10 Parts by mass of the emulsion (A2) of the pesticidal active compound, 21.97 parts by mass of the suspension (B1) of the pesticidal active compound, 20.40 parts by mass of the thickener-containing liquid (C1) and 0.067 parts by mass of XIAMETER ACP-1500 were stirred and mixed to obtain 75.54 parts by mass of a premixture (D3).

### <Preparation of Premixture (D4)>

37.21 Parts by mass of an aqueous Dicamba DGA solution (concentration of dicamba acid: 39.5% by mass), 21.97 parts by mass of the suspension (B2) of the pesticidal active compound, 20.40 parts by mass of the thickener-containing liquid (C1) and 0.13 part by mass of XIAMETER ACP-1500 were stirred and mixed to obtain 79.71 parts by mass of a premixture (D4).

### <Preparation of Premixture (D5)>

44.06 Parts by mass of the emulsion (A1) of the pesticidal active compound, 20.40 parts by mass of the thickener-containing liquid (C1) and 0.13 part by mass of XIAMETER ACP-1500 were stirred and mixed to obtain 64.53 parts by mass of a premixture (D5).

### <Preparation of Premixture (D6)>

37.21 Parts by mass of an aqueous Dicamba DGA solution (concentration of dicamba acid: 39.5% by mass), 21.97 parts by mass of the suspension (B1) of the pesticidal active compound, 20.40 parts by mass of the thickener-containing liquid (C1) and 0.13 part by mass of XIAMETER ACP-1500 were stirred and mixed to obtain 79.71 parts by mass of a premixture (D6).

### <Preparation of Premixture (D7)>

46.95 Parts by mass of the emulsion (A3) of the pesticidal active compound, 21.97 parts by mass of the suspension (B1) of the pesticidal active compound, 20.40 parts by mass of the thickener-containing liquid (C1) and 0.067 part by mass of XIAMETER ACP-1500 were stirred and mixed to obtain 89.39 parts by mass of a premixture (D7).

### <Comparative Production Example 1>

To 86.50 parts by mass of the premixture (D1), a solution obtained by mixing 9.26 parts by mass of ion-exchanged water, 3.00 parts by mass of acetic acid and 1.24 parts by mass of potassium hydroxide was added, followed by stirring and mixing to obtain a comparative pesticidal composition (Y1).

### <Comparative Production Example 2>

To 86.50 parts by mass of the premixture (D1), a solution obtained by mixing 8.75 parts by mass of ion-exchanged water, 3.69 parts by mass of propionic acid and 1.06 parts by mass of potassium hydroxide was added, followed by stirring and mixing to obtain a comparative pesticidal composition (Y2).

### Production Example 1

To 86.50 parts by mass of the premixture (D1), a solution obtained by mixing 8.67 parts by mass of ion-exchanged water, 3.59 parts by mass of polyacrylic acid 5,000 and 1.24 parts by mass of potassium hydroxide was added, followed by stirring and mixing to obtain a present pesticidal composition (X1).

### Production Example 2

To 90.65 parts by mass of the premixture (D2), a solution obtained by mixing 4.00 parts by mass of ion-exchanged water, 3.59 parts by mass of polyacrylic acid 5,000 and 1.76 parts by mass of potassium hydroxide was added, followed by stirring and mixing to obtain a present pesticidal composition (X2).

### Production Example 3

To 86.50 parts by mass of the premixture (D1), a solution obtained by mixing 7.92 parts by mass of ion-exchanged water, 3.38 parts by mass of AQUALIC TL-37 and 2.20 parts by mass of polyacrylic acid 5,000 was added, followed by stirring and mixing to obtain a present pesticidal composition (X3).

### Production Example 4

To 86.50 parts by mass of the premixture (D1), a solution obtained by mixing 8.67 parts by mass of ion-exchanged water, 3.59 parts by mass of polyacrylic acid 25,000 and 1.24 parts by mass of potassium hydroxide was added, followed by stirring and mixing to obtain a present pesticidal composition (X4).

### Production Example 5

To 86.50 parts by mass of the premixture (D1), a solution obtained by mixing 8.83 parts by mass of ion-exchanged water, 3.59 parts by mass of polyacrylic acid 5,000 and 1.08 parts by mass of sodium hydroxide was added, followed by stirring and mixing to obtain a present pesticidal composition (X5).

### Comparative Production Example 3

To 75.54 parts by mass of the premixture (D3), a solution obtained by mixing 11.43 parts by mass of ion-exchanged water, 7.99 parts by mass of acetic acid and 5.04 parts by mass of potassium hydroxide was added, followed by stirring and mixing to obtain a comparative pesticidal composition (Y3).

### Production Example 6

To 75.54 parts by mass of the premixture (D3), a solution obtained by mixing 9.85 parts by mass of ion-exchanged water, 9.57 parts by mass of polyacrylic acid 5,000 and 5.04 parts by mass of potassium hydroxide was added, followed by stirring and mixing to obtain a present pesticidal composition (X6).

### Comparative Production Example 4

To 79.71 parts by mass of the premixture (D4), a solution obtained by mixing 16.05 parts by mass of ion-exchanged water, 3.00 parts by mass of acetic acid and 1.24 parts by mass of potassium hydroxide was added, followed by stirring and mixing to obtain a comparative pesticidal composition (Y4).

### Production Example 7

To 79.71 parts by mass of the premixture (D4), a solution obtained by mixing 15.46 parts by mass of ion-exchanged water, 3.59 parts by mass of polyacrylic acid 5,000 and 1.24 parts by mass of potassium hydroxide was added, followed by stirring and mixing to obtain a present pesticidal composition (X7).

### Comparative Production Example 5

To 64.53 parts by mass of the premixture (D5), a solution obtained by mixing 31.23 parts by mass of ion-exchanged water, 3.00 parts by mass of acetic acid and 1.24 parts by mass of potassium hydroxide was added, followed by stirring and mixing to obtain a comparative pesticidal composition (Y5).

### Production Example 8

To 64.53 parts by mass of the premixture (D5), a solution obtained by mixing 30.64 parts by mass of ion-exchanged water, 3.59 parts by mass of polyacrylic acid 5,000 and 1.24 parts by mass of potassium hydroxide was added, followed by stirring and mixing to obtain a present pesticidal composition (X8).

### Comparative Production Example 6

To 79.71 parts by mass of the premixture (D6), a solution obtained by mixing 16.05 parts by mass of ion-exchanged water, 3.00 parts by mass of acetic acid and 1.24 parts by mass of potassium hydroxide was added, followed by stirring and mixing to obtain a comparative pesticidal composition (Y6).

### Production Example 9

To 79.71 parts by mass of the premixture (D6), a solution obtained by mixing 15.46 parts by mass of ion-exchanged water, 3.59 parts by mass of polyacrylic acid 5,000 and 1.24 parts by mass of potassium hydroxide was added, followed by stirring and mixing to obtain a present pesticidal composition (X9).

### Comparative Production Example 7

To 89.39 parts by mass of the premixture (D7), a solution obtained by mixing 5.85 parts by mass of ion-exchanged water, 3.00 parts by mass of acetic acid and 1.76 parts by mass of potassium hydroxide was added, followed by stirring and mixing to obtain a comparative pesticidal composition (Y7).

### Production Example 10

To 89.39 parts by mass of the premixture (D7), a solution obtained by mixing 5.26 parts by mass of ion-exchanged water, 3.59 parts by mass of polyacrylic acid 5,000 and 1.76 parts by mass of potassium hydroxide was added, followed by stirring and mixing to obtain a present pesticidal composition (X10).

Table 1 and Table 2 show each composition of the present pesticidal compositions (X1) to (X10) and the comparative pesticidal compositions (Y1) to (Y7). The unit of the content of each ingredient shown in Table 1 and Table 2 is % by mass.

### Test Example 1: Evaluation of Residual Ratio of Compound (I)

Each of the present pesticidal compositions (X1) to (X10) and the comparative pesticidal compositions (Y1) to (Y7) was charged in a screw tube and then left to stand in an incubator at 54° C. for 14 days. The content of the compound (I) in each pesticidal composition after storage was then analyzed by HPLC, and then the residual ratio of the compound (I) was evaluated using the calculation formula below. The results are shown in Table 1 and Table 2. The higher the residual ratio of the compound (I), the higher the inhibitory effect on decomposition of the compound (I).

$$Residual ratio [ \% ] of compound ( I ) = 100 \times A / B$$

A: Content of compound (I) in each pesticidal composition after storage at 54° C. for 14 days
B: Content of compound (I) in each pesticidal composition immediately after preparation

### Test Example 2: Identification of Decomposition Product of Compound (I)

Mass spectra were measured for compositions containing the compound (I-A), the compound (I-B), a dicamba diglycolamine salt, acetic acid and potassium hydroxide, which were left to stand in an incubator at 50° C. for 8 weeks. As a result, the followings were confirmed: decomposition products a and b represented by formulas below, which are decomposition products of the compound (I-A), and a decomposition product c represented by formula below, which is a decomposition product of the compound (I-B).

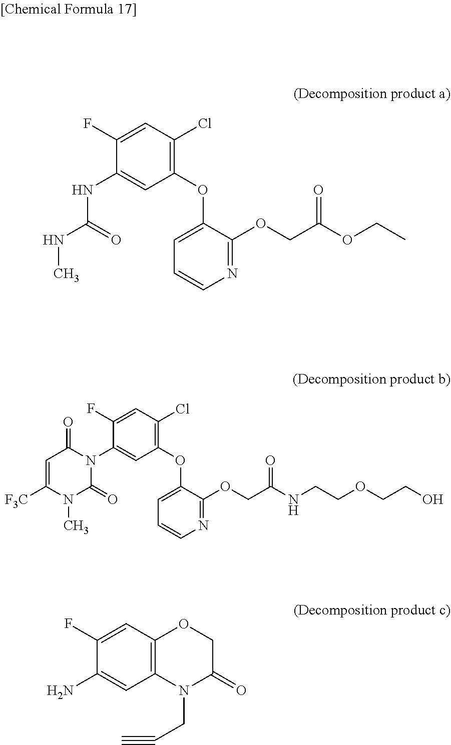 [SMILES: CCOC(=O)COc1ncccc1Oc1cc(NC(=O)NC)c(F)cc1Cl ; Cn1c(C(F)(F)F)cc(=O)n(-c2cc(Oc3cccnc3OCC(=O)NCCOCCO)c(Cl)cc2F)c1=O ; C#CCN1C(=O)COc2cc(F)c(N)cc21]

The decomposition product a is obtained as a result of ring-opening of a uracil ring due to the cleavage of a C—N bond (bond between an N atom at the 3-position and a C atom at the 4-position) included in an imide structure constituting a uracil ring structure of the compound (I-A), and a bond between an N atom at the 1-position and a C atom at the 6-position. The decomposed product b is obtained as a result of the addition of diglycolamine (DGA) to the terminal ethyl ester moiety, in addition to the ring-opening of the uracil ring of the compound (I-A). The decomposition product c is obtained as a result of the cleavage of two C—N bonds included in the imide structure of the compound (I-B).

From the results of Test Example 2, it can be understood that the technology of the present invention is effective in inhibiting decomposition of compounds having an amide structure, a uracil ring structure or imide structure including the amide structure, or an ester structure.

### Test Example 3: Evaluation of Volatilization Amount of Dicamba

### (1) Preparation of Measurement Sample

For each of the present pesticidal compositions (X1) to (X10) and the comparative pesticidal compositions (Y1) to (Y7), 8.16 parts by mass of each pesticidal composition was mixed with 6.03 parts by mass of Roundup PowerMAX (registered trademark) (Bayer CropScience product containing 48.7% by mass of a glyphosate potassium salt) and 85.81 parts by mass of ion-exchanged water to prepare 100 parts by mass of a diluted solution of each pesticidal composition, which was used as a measurement sample.

Also, 3.01 parts by mass of Clarity (registered trademark) (BASF product containing 58.1% by mass of a dicamba diglycolamine salt) was mixed with 6.03 parts by mass of Roundup PowerMAX and 90.96 parts by mass of ion-exchanged water to prepare 100 parts by mass of a control.

### (2) Evaluation of Volatilization Amount of Dicamba

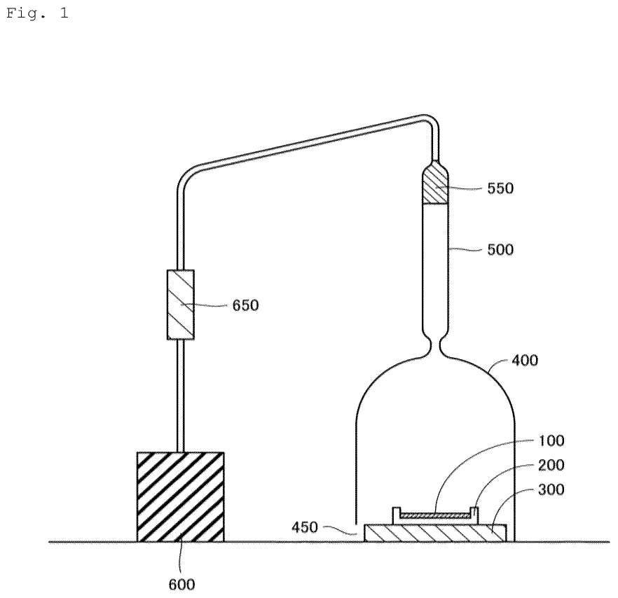

A description will be made with reference to FIG. 1 which is a schematic cross-sectional view showing an evaluation device. A glass petri dish 200 having a diameter of 6.5 cm, added with the whole amount of a measurement sample 100 prepared in (1) above, was placed on a temperature control mat 300 (round type SAMICON 230 heater, manufactured by SAKAGUCHI E.H VOC CORP.). A dome-shaped glass cover 400 was put over it. The cover 400 has an opening at the top and a plurality of notches 450 for taking outside air at regular intervals at the bottom. A connection tube 500 was connected to the opening at the top of the cover 400, and the connection tube 500 was connected to a suction pump 600 by a tube. In this case, a fiowmeter 650 was disposed between the connection tube 500 and the suction pump 600. A polyurethane foam 550 (manufactured by SKC Inc., diameter: 22 mm, length: 76 mm) was disposed inside the connection tube 500.

In a state where the temperature control mat 300 is controlled at 35° C., the suction pump 600 was activated to take outside air from the notches 450, thus generating a flow of gas that flows to the suction pump 600. The gas suction rate was set at 2 L/min. The suction pump 600 was continuously operated for 24 hours. The polyurethane foam 550 was then collected, and dicamba absorbed in the polyurethane foam 550 was extracted with methanol, followed by quantitative analysis using LC-MS. The amount of dicamba extracted from the quantitative analysis corresponds to the volatilization amount of dicamba. The same test was carried out for the control.

When the volatilization amount of dicamba in the control is defined as 1, the relative value of the volatilization amount of dicamba in the diluted solutions of each pesticidal composition was calculated. The results are shown in Table 1 and Table 2.

### Test Example 4: Measurement of pH of Pesticidal Composition

The pH value at 25° C. of each of the present pesticidal compositions (X1) to (X10) and the comparative pesticidal compositions (Y1) to (Y7) was measured according to the following procedure. Each pesticidal composition was charged in a glass container and shaken by hand. An electrode of a pH meter (“Tabletop pH meter F-71S”, manufactured by HORIBA, Ltd.) was dipped in the pesticidal composition and then the pH value was then measured. The results are shown in Table 1 and Table 2.

TABLE 1

| | | Comparative | | | | | | |
|---|---|---|---|---|---|---|---|---|
| | | Production | | | | | | |
| | | Example | | Production Example | | | | |
| | | 1 | 2 | 1 | 2 | 3 | 4 | 5 |
| Pesticidal composition No. | | (Y1) | (Y2) | (X1) | (X2) | (X3) | (X4) | (X5) |
| Dicamba | Dicamba-DGA | 14.7 | 14.7 | 14.7 | 14.7 | 14.7 | 14.7 | 14.7 |
| amine salt | Dicamba-MEA | | | | | | | |
| Compound | Compound (I-A) | 0.53 | 0.53 | 0.53 | 0.53 | 0.53 | 0.53 | 0.53 |
| (I) | Compound (I-B) | 2.28 | 2.28 | 2.28 | 2.28 | 2.28 | 2.28 | 2.28 |
| | Compound (I-C) | | | | | | | |
| Organic | Solvesso 200ND | 5.25 | 5.25 | 5.25 | 5.25 | 5.25 | 5.25 | 5.25 |
| solvent | | | | | | | | |
| Surfactant | Pluronic P-104 | 1.00 | 1.00 | 1.00 | 1.00 | 1.00 | 1.00 | 1.00 |
| | Reax 910 | 4.00 | 4.00 | 4.00 | 4.00 | 4.00 | 4.00 | 4.00 |
| | Synpcronic | 0.50 | 0.50 | 0.50 | 0.50 | 0.50 | 0.50 | 0.50 |
| | PE/F 127 | | | | | | | |
| Thickener | Kelzan AP-AS | 0.20 | 0.20 | 0.20 | 0.20 | 0.20 | 0.20 | 0.20 |
| | Veegum R | 0.40 | 0.40 | 0.40 | 0.40 | 0.40 | 0.40 | 0.40 |
| Defoamer | XIAMETER | 0.20 | 0.20 | 0.20 | 0.20 | 0.20 | 0.20 | 0.20 |
| | ACP-1500 | | | | | | | |
| Preservative | Peoxel GXL | 0.20 | 0.20 | 0.20 | 0.20 | 0.20 | 0.20 | 0.20 |
| Other | NaCl | | | | 4.15 | | | |
| additives | | | | | | | | |
| Acid or salt | Acetic acid | 3.00 | | | | | | |
| thereof | Propionic acid | | 3.69 | | | | | |
| | Polyacrylic | | | 3.59 | 3.59 | 2.20 | | 3.59 |
| | acid 5,000 | | | | | | | |
| | Polyacrylic | | | | | | 3.59 | |
| | acid 25,000 | | | | | | | |
| | AQUALIC TL-37 | | | | | 3.38 | | |
| Basic | Potassium | 1.05 | 1.05 | 1.05 | 1.05 | | 1.05 | |
| component | hydroxide | | | | | | | |
| | Sodium | | | | | | | 1.05 |
| | hydroxide | | | | | | | |
| Water | Ion-exchanged | 66.69 | 66.15 | 66.10 | 61.50 | 65.16 | 66.10 | 66.10 |
| | water | | | | | | | |
| Total (% by mass) | | 100 | 100 | 100 | 100 | 100 | 100 | 100 |
| Residual | Compound (I-A) | 92 | 92 | 96 | 98 | 95 | 96 | 96 |
| ratio (%) of | Compound (I-B) | 93 | 93 | 96 | 97 | 94 | 95 | 95 |
| compound | Compound (I-C) | — | — | — | — | — | — | — |
| (I) | | | | | | | | |

| | | | | | | | |
|---|---|---|---|---|---|---|---|
| Volatilization amount of | 0.20 | 0.15 | 0.23 | 0.21 | 0.20 | 0.22 | 0.22 |
| dicamba (relative value) | | | | | | | |
| pH value of pesticidal | 5.0 | 5.1 | 5.0 | 5.3 | 5.1 | 5.0 | 5.2 |
| composition | | | | | | | |

TABLE 2

| | | Comparative | | Comparative | | Comparative |
|---|---|---|---|---|---|---|
| | | Production | Production | Production | Production | Production |
| | | Example | Example | Example | Example | Example |
| | | 3 | 6 | 4 | 7 | 5 |
| Pesticidal composition No. | | (Y3) | (X6) | (Y4) | (X7) | (Y5) |
| Dicamba | Dicamba-DGA | | | 14.7 | 14.7 | 14.7 |
| amine salt | Dicamba-MEA | 14.7 | 14.7 | | | |
| Compound | Compound (I-A) | 0.53 | 0.53 | | | 0.53 |
| (I) | Compound (I-B) | 2.28 | 2.28 | | | |
| | Compound (I-C) | | | 2.28 | 2.28 | |
| Organic | Solvesso 200ND | 5.25 | 5.25 | 5.25 | 5.25 | 5.25 |
| solvent | | | | | | |
| Surfactant | Pluronic P-104 | 1.00 | 1.00 | 1.00 | 1.00 | 1.00 |
| | Selvol 523 | | | | | |
| | Reax 910 | 4.00 | 4.00 | 4.00 | 4.00 | 4.00 |
| | Synperonic | 0.50 | 0.50 | 0.50 | 0.50 | 0.50 |
| | PE/F 127 | | | | | |
| Thickener | Kelzan | 0.20 | 0.20 | 0.20 | 0.20 | 0.20 |
| | AP-AS | | | | | |
| | Veegum R | 0.40 | 0.40 | 0.40 | 0.40 | 0.40 |
| Defoamer | XIAMETER | 0.20 | 0.20 | 0.20 | 0.20 | 0.20 |
| | ACP-1500 | | | | | |
| Preservative | Peoxel GXL | 0.20 | 0.20 | 0.20 | 0.20 | 0.20 |
| Other | NaCl | | | | | |
| additives | | | | | | |
| Acid or salt | Acetic acid | 2.90 | | 3.00 | | 3.00 |
| thereof | Propionic acid | | | | | |
| | Polyacrylic | | 9.57 | | 3.59 | |
| | acid 5,000 | | | | | |
| | Polyacrylic | | | | | |
| | acid 25,000 | | | | | |
| | AQUALIC | | | | | |
| | TL-37 | | | | | |
| Basic | Potassium | 4.28 | 4.28 | 1.05 | 1.05 | 1.05 |
| component | hydroxide | | | | | |
| | Sodium | | | | | |
| | hydroxide | | | | | |
| Water | Ion-exchanged | 58.47 | 56.89 | 67.22 | 66.63 | 68.97 |
| | water | | | | | |
| Total (% by mass) | | 100 | 100 | 100 | 100 | 100 |
| Residual | Compound (I-A) | 88 | 94 | — | — | 91 |
| ratio (%) of | Compound (I-B) | 88 | 94 | — | — | — |
| compound | Compound (I-C) | — | — | 90 | 96 | — |
| (I) | | | | | | |

| | | | | | |
|---|---|---|---|---|---|
| Volatilization amount of | 0.18 | 0.20 | — | — | — |
| dicamba(relative value) | | | | | |
| pH value of pesticidal | 5.3 | 5.3 | 4.9 | 5.0 | 4.9 |
| composition | | | | | |

| | | | Comparative | | Comparative | |
|---|---|---|---|---|---|---|
| | | Production | Production | Production | Production | Production |
| | | Example | Example | Example | Example | Example |
| | | 8 | 6 | 9 | 7 | 10 |
| Pesticidal composition No. | | (X8) | (Y6) | (X9) | (Y7) | (X10) |
| Dicamba | Dicamba-DGA | 14.7 | 14.7 | 14.7 | 14.7 | 14.7 |
| amine salt | Dicamba-MEA | | | | | |
| Compound | Compound (I-A) | 0.53 | | | 0.53 | 0.53 |
| (I) | Compound (I-B) | | 2.28 | 2.28 | 2.28 | 2.28 |
| | Compound (I-C) | | | | | |
| Organic | Solvesso 200ND | 5.25 | 5.25 | 5.25 | 5.25 | 5.25 |
| solvent | | | | | | |
| Surfactant | Pluronic P-104 | 1.00 | 1.00 | 1.00 | | |
| | Selvol 523 | | | | 0.35 | 0.35 |
| | Reax 910 | 4.00 | 4.00 | 4.00 | 4.00 | 4.00 |
| | Synperonic | 0.50 | 0.50 | 0.50 | 0.50 | 0.50 |
| | PE/F 127 | | | | | |
| Thickener | Kelzan | 0.20 | 0.20 | 0.20 | 0.20 | 0.20 |
| | AP-AS | | | | | |
| | Veegum R | 0.40 | 0.40 | 0.40 | 0.40 | 0.40 |
| Defoamer | XIAMETER | 0.20 | 0.20 | 0.20 | 0.20 | 0.20 |
| | ACP-1500 | | | | | |
| Preservative | Peoxel GXL | 0.20 | 0.20 | 0.20 | 0.20 | 0.20 |
| Other | NaCl | | | | | |
| additives | | | | | | |
| Acid or salt | Acetic acid | | 3.00 | | 3.00 | |
| thereof | Propionic acid | | | | | |
| | Polyacrylic | 3.59 | | 3.59 | | 3.59 |
| | acid 5,000 | | | | | |
| | Polyacrylic | | | | | |
| | acid 25,000 | | | | | |
| | AQUALIC | | | | | |
| | TL-37 | | | | | |
| Basic | Potassium | 1.05 | 1.05 | 1.05 | 1.50 | 1.50 |
| component | hydroxide | | | | | |
| | Sodium | | | | | |
| | hydroxide | | | | | |
| Water | Ion-exchanged | 68.38 | 67.22 | 66.63 | 66.89 | 66.30 |
| | water | | | | | |
| Total (% by mass) | | 100 | 100 | 100 | 100 | 100 |
| Residual | Compound (I-A) | 98 | — | — | 92 | 96 |
| ratio (%) of | Compound (I-B) | — | 92 | 96 | 90 | 95 |
| compound | Compound (I-C) | — | — | — | — | — |
| (I) | | | | | | |

| | | | | | |
|---|---|---|---|---|---|
| Volatilization amount of | — | — | — | — | — |
| dicamba(relative value) | | | | | |
| pH value of pesticidal | 5.0 | 4.9 | 5.0 | 5.3 | 5.3 |
| composition | | | | | |

### Test Example 5

The present pesticidal compositions (Z1) to (Z5) shown in Table 3 are prepared according to the method for preparing the above-mentioned present pesticidal compositions (X1) to (X10) and comparative pesticidal compositions (Y1) to (Y7). The unit of the content of each ingredient shown in Table 3 is % by mass.

For each of the present pesticidal compositions (Z1) to (Z5), the residual ratio of the compound (I) and the volatilization amount of 2,4-D are evaluated according to the above-mentioned Test Examples [1] and [3], respectively. As a result, it is confirmed that all of the present pesticidal compositions (Z1) to (Z5) are pesticidal compositions capable of inhibiting volatilization of 2,4-D and inhibiting decomposition of the compound (I).

TABLE 3

| | | Test Example 5 | | | | |
|---|---|---|---|---|---|---|
| Pesticidal composition No. | | (Z1) | (Z2) | (Z3) | (Z4) | (Z5) |
| 2,4-D salt | 2,4-D choline(as 2,4-D | 17.5 | 17.5 | 17.5 | 10.0 | 25.0 |
| | acid equivalent) | | | | | |
| Compound (I) | Compound (I-A) | 0.53 | 0.53 | | 0.53 | 0.53 |
| | Compound (I-B) | 2.28 | | 2.28 | | |
| Organic solvent | Solvesso 200ND | 5.25 | 5.25 | | 20.00 | 10.00 |
| Surfactant | Pluronic P-104 | 1.00 | 0.50 | | 2.00 | 1.00 |
| | Reax 910 | 4.00 | | 2.00 | | |
| | Synperonic PE/F 127 | 0.50 | | 0.25 | | |
| Thickener | Kelzan AP-AS | 0.20 | 0.20 | 0.20 | 0.20 | 0.20 |
| | Veegum R | 0.40 | 0.40 | 0.40 | 0.40 | 0.40 |
| Defoamer | XIAMETER ACP-1500 | 0.20 | 0.20 | 0.20 | 0.20 | 0.20 |
| Preservative | Peoxel GXL | 0.20 | 0.20 | 0.20 | 0.20 | 0.20 |
| Acid or salt thereof | Polyacrylic acid 5,000 | 3.59 | 3.59 | 3.59 | 3.59 | 7.18 |
| Basic component | Potassium hydroxide | 1.50 | 1.50 | 1.50 | | 3.00 |
| | Sodium hydroxide | | | | 1.50 | |
| Water | Ion-exchanged water | 62.85 | 70.13 | 71.88 | 61.38 | 52.29 |

| | | | | | |
|---|---|---|---|---|---|
| Total (% by mass) | 100 | 100 | 100 | 100 | 100 |

### DESCRIPTION OF REFERENCE NUMERALS

100: Measurement sample, 200: Glass petri dish, 300: Temperature control mat, 400: Cover, 450: Notches, 500: Connection tube, 550: Polyurethane foam, 600: Suction pump, 650: Flowmeter

1. A liquid pesticidal composition comprising:
at least one herbicide selected from the group consisting of an auxin herbicide and an agriculturally acceptable salt or ester thereof;
a pesticidal active compound having a partial structure represented by the following formula (I):
—C(═O)—X— (I)
wherein X represents at least one selected from the group consisting of an oxygen atom and NR¹, and R¹ represents a monovalent group; and
at least one selected from the group consisting of a polycarboxylic acid and a salt thereof.

2. The liquid pesticidal composition according to claim 1, wherein at least one herbicide comprises a dicamba amine salt.

3. The liquid pesticidal composition according to claim 2, wherein the pesticidal active compound is a compound represented by the following formula (I-1): 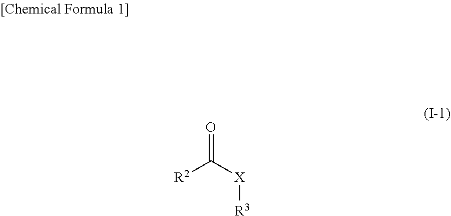
wherein X is as defined above,
R² represents a monovalent group,
R³ represents a monovalent group when X is an oxygen atom, or C(═O)—R⁴ when X is NR¹, and
R⁴ represents a monovalent group, and R² and R⁴ may form a ring together with the carbon atom to which R² is bonded, X and the carbon atom to which R⁴ is bonded.

4. The liquid pesticidal composition according to claim 2, wherein the polycarboxylic acid comprises at least one polycarboxylic acid selected from the group consisting of a copolymer of acrylic acid and maleic acid, and polyacrylic acid.

5. The liquid pesticidal composition according to claim 2, wherein the dicamba amine salt comprises at least one dicamba amine salt selected from the group consisting of a dicamba diglycolamine salt and a dicamba monoethanolamine salt.

6. The liquid pesticidal composition according to claim 2, further comprising a basic component.

7. The liquid pesticidal composition according to claim 2, further comprising an alkali metal hydroxide.

8. The liquid pesticidal composition according to claim 2, further comprising at least one alkali metal hydroxide selected from the group consisting of a potassium hydroxide and a sodium hydroxide.

9. The liquid pesticidal composition according to claim 6, wherein the concentration of the basic component is 0.0001 mol/L or more and 0.050 mol/L or less.

10. The liquid pesticidal composition according to claim 2, wherein the pesticidal active compound comprises a PPO inhibitor.
